(19) United States
(12) Patent Application Publication
(10) Pub. No.: US 2026/0101275 A1
(43) Pub. Date: Apr. 9, 2026

(54) ELECTRONIC DEVICE FOR PROVIDING SHORT-RANGE WIRELESS COMMUNICATION THROUGH NAN DATA PATH AND METHOD FOR THE SAME

(71) Applicant: SAMSUNG ELECTRONICS CO., LTD., Suwon-si (KR)

(72) Inventors: Buseop JUNG, Suwon-Si (KR); Sunkee LEE, Suwon-si (KR)

(73) Assignee: SAMSUNG ELECTRONICS CO., LTD., Suwon-si (KR)

(21) Appl. No.: 19/367,366

(22) Filed: Oct. 23, 2025

Related U.S. Application Data
(63) Continuation of application No. PCT/KR2025/015358, filed on Sep. 29, 2025.

(30) Foreign Application Priority Data
Oct. 31, 2024 (KR) 10-2024-0152660
Oct. 4, 2024 (KR) 10-2024-0134926

(51) Int. Cl. H04W 48/16; H04W 4/80; H04W 88/04

(52) U.S. Cl. CPC H04W 48/16; H04W 4/80; H04W 88/04

(57) ABSTRACT

A method of an electronic device, includes: receiving, from an external device, a service discovery frame for discovering the external device to be connected through a first neighbor awareness network data path (NDP) of NAN communication, wherein the service discovery frame includes: first information related to a second access point (AP) connected to the external device, or second information indicating whether a cross-connection is supported, wherein the cross-connection is a function enabling the electronic device to be connected to the second AP via the external device, activating, based on the service discovery frame, the cross-connection enabling the external device to be connected to a first AP via the electronic device, and transmitting, to the external device, schedule information related to the electronic device and the external device configured to perform the NAN communication via the first NDP and to perform short-range wireless communication using the cross-connection.

### CROSS-REFERENCE TO RELATED APPLICATIONS

This application is a by-pass continuation application of International Application No. PCT/KR2025/015358, filed on September 29, 2025, which is based on and claims priority to Korean Patent Application No. 10-2024-0134926, filed on October 4, 2024, and Korean Patent Application No. 10-2024-0152660, filed on October 31, 2024, in the Korean Intellectual Property Office, the disclosures of which are incorporated by reference herein their entireties.

### BACKGROUND

### 1. Field

The disclosure relates to an electronic device and an operating method of the electronic device. The disclosure relates to an electronic device configured to provide short-range wireless communication via a neighbor awareness networking (NAN) data path (NDP).

### 2. Description of Related Art

With the proliferation of various electronic devices, advancements in wireless communication speeds for these devices have been realized.

In addition, various types of proximity services utilizing low-power discovery technology have been developed. For example, proximity services (or proximity communication services) that allow neighboring electronic devices to quickly exchange data through a proximity network have been developed.

The proximity services may include low-power proximity services using Bluetooth low energy (BLE) beacons, or low-power proximity services based on wireless local area network (WLAN)-based low-power short-range communication technologies (e.g., neighbor awareness networking (NAN), Wi-Fi aware) (“NAN”).

An NAN-based low-power proximity service (“proximity service”) utilizes a proximity network that dynamically changes according to the movement of an electronic device. A set of electronic devices that constitutes a proximity network may be referred to as a cluster. In the case of the proximity service, electronic devices included in the cluster may transmit and receive a signal for discovery (e.g., a beacon) and a service discovery frame (SDF) (“SDF”) within a synchronized time duration (or a communication period). For example, at least one electronic device within the cluster may transmit a signal to indicate the cluster’s presence, and a new electronic device attempting to join the cluster may receive that signal.

Each electronic device in the cluster may configure different active durations for transmitting and receiving signals in order to reduce current consumption (or power consumption). In NAN communication, the active duration during which signals may be transmitted and received may be referred to as a discovery window (DW). In addition, electronic devices included in the cluster may reduce current consumption by maintaining a low-power state (e.g., sleep state) during periods excluding the discovery window.

If an electronic device has a relatively large amount of data to be transmitted or received via NAN communication, it may not be able to complete the transmission and/or reception of the data during the discovery window. The electronic device may perform the transmission and/or reception of relatively large-sized data by performing data transmission and/or reception in a period other than the discovery window. If both NAN communication and other short-range wireless communication are activated, the electronic device may need to perform not only NAN communication but also other short-range wireless communication between discovery windows.

The electronic device is configured to perform short-range wireless communication during at least a portion of the period between the discovery windows, and cannot perform NAN communication during the configured period. If NAN communication cannot be performed during the configured period, a degradation in the quality of a service using NAN communication may occur. For example, if the service using NAN communication is a service requiring low latency (e.g., screen mirroring or multi-device service), the inability to perform NAN communication during the configured period may lead to a degradation in service quality.

The technical problems to be solved in embodiments of the disclosure are not limited to those mentioned above, and other technical problems not mentioned may be clearly understood from the description below by a person skilled in the technical field to which the disclosure belongs.

### SUMMARY

An electronic device according to an example may include a communication circuitry supporting short-range wireless communication and neighbor awareness network (NAN) communication. The electronic device may include a memory storing at least one computer program. The electronic device may include at least one processor. Instructions included in the at least one computer program may cause, when executed by the at least one processor individually or collectively, the electronic device to be connected to a first access point (AP) via the short-range wireless communication. The instructions included in the at least one computer program may cause, when executed by the at least one processor individually or collectively, the electronic device to receive, from an external electronic device, a service discovery frame in a process of discovering the external electronic device to be connected through a first NAN data path (NDP), wherein the service discovery frame includes information related to a second AP connected to the external electronic device and/or information indicating whether a cross-connection which is a function enabling the electronic device to be connected to the second AP via the external electronic device is supported. The instructions included in the at least one computer program may cause, when executed by the at least one processor individually or collectively, the electronic device to activate, based on the service discovery frame, the cross-connection enabling the external electronic device to be connected to the first AP via the electronic device. The instructions included in the at least one computer program may cause, when executed by the at least one processor individually or collectively, the electronic device to transmit, to the external electronic device, schedule information related to performing the NAN communication via the first NDP and performing the short-range wireless communication using the cross-connection. The schedule information may cause the electronic device and the external electronic device to perform the NAN communication and the short-range wireless communication using the cross-connection during a first period between discovery windows and perform the NAN communication during a second period between the discovery windows.

In a recording medium storing at least one program including instructions that, when executed by at least one processor of an electronic device individually or collectively, cause the electronic device to perform operations, the instructions may cause, when executed, the electronic device to receive, from an external electronic device, a service discovery frame in a process of discovering the external electronic device to be connected through a first NDP of NAN communication, wherein the service discovery frame includes information related to a second AP connected to the external electronic device and/or information indicating whether a cross-connection which is a function enabling the electronic device to be connected to the second AP via the external electronic device is supported. The instructions may cause, when executed, the electronic device to activate, based on the service discovery frame, the cross-connection enabling the external electronic device to be connected to a first AP via the electronic device. The instructions may cause, when executed, the electronic device to transmit, to the external electronic device, schedule information related to performing the NAN communication via the first NDP and performing the short-range wireless communication using the cross-connection. The schedule information may cause the electronic device and the external electronic device to perform the NAN communication and the short-range wireless communication using the cross-connection during a first period between discovery windows and perform the NAN communication during a second period between the discovery windows.

An electronic device according to an example may include a communication circuitry supporting short-range wireless communication and neighbor awareness network (NAN) communication. The electronic device may include a memory storing at least one computer program. The electronic device may include at least one processor. Instructions included in the at least one computer program may cause, when executed by the at least one processor individually or collectively, the electronic device to be connected to a first AP via the short-range wireless communication. The instructions included in the at least one computer program may cause, when executed by the at least one processor individually or collectively, the electronic device to receive, from an external electronic device, a service discovery frame in a process of discovering the external electronic device to be connected through a first NDP of the NAN communication, wherein the service discovery frame includes information related to a second AP connected to the external electronic device and/or information indicating whether a cross-connection which is a function enabling the electronic device to be connected to the second AP via the external electronic device is supported. The instructions included in the at least one computer program may cause, when executed by the at least one processor individually or collectively, the electronic device to activate, based on the service discovery frame, the cross-connection enabling the electronic device to be connected to the second AP via the external electronic device. The instructions included in the at least one computer program may cause, when executed by the at least one processor individually or collectively, the electronic device to transmit, to the external electronic device, schedule information related to the electronic device and the external electronic device performing communication via the first NDP and performing the short-range wireless communication using the cross-connection. The schedule information may cause the electronic device and the external electronic device to perform the NAN communication and the short-range wireless communication using the cross-connection during a first period between discovery windows and perform the NAN communication during a second period between the discovery windows.

An operating method of an electronic device according to an example may include an operation of receiving, from an external electronic device, a service discovery frame in a process of discovering the external electronic device to be connected through a first NDP of NAN communication, wherein the service discovery frame includes information related to a second AP connected to the external electronic device and/or information indicating whether a cross-connection which is a function enabling the electronic device to be connected to the second AP via the external electronic device is supported. The operating method of the electronic device may include an operation of activating, based on the service discovery frame, the cross-connection enabling the external electronic device to be connected to a first AP via the electronic device. The operating method of the electronic device may include an operation of transmitting, to the external electronic device, schedule information related to the electronic device and the external electronic device performing the NAN communication via the first NDP and performing the short-range wireless communication using the cross-connection. The schedule information may causes the electronic device and the external electronic device to perform the NAN communication and the short-range wireless communication using the cross-connection during a first period between discovery windows and perform the NAN communication during a second period between the discovery windows.

In an electronic device and an operating method thereof according to an example, the electronic device can provide a cross-connection that allows an external electronic device performing NAN communication together through an NDP to be connected to an AP, connected to the electronic device, through the NDP established between the electronic device and the external electronic device. The electronic device can provide the cross-connection to the external electronic device, and configure schedule information so that the external electronic device and the electronic device perform the NAN communication and communication using a cross-connection function during a first period between discovery windows, and perform the NAN communication during a second period. The communication using the cross-connection may be performed via the NDP, and thus the electronic device can perform the communication using the cross-connection and the NAN communication simultaneously. Therefore, the electronic device can perform the NAN communication during most of a period between the discovery windows, and prevent deterioration of the quality of a service using the NAN communication.

The effects obtainable from the disclosure are not limited to those mentioned above, and other effects not mentioned can be clearly understood from the description below by a person skilled in the art to which the disclosure belongs.

### BRIEF DESCRIPTION OF THE DRAWINGS

FIG. 1 illustrates an electronic device according to an embodiment;

FIG. 2 illustrates a neighbor awareness network (NAN) cluster according to an embodiment;

FIG. 3 illustrates a protocol for transmitting a signal of an electronic device included in an NAN cluster according to an embodiment;

FIG. 4 illustrates an example of data transmission and reception within an NAN cluster according to an embodiment;

FIG. 5A illustrates an electronic device and an external electronic device according to an embodiment;

FIG. 5B illustrates an example of an electronic device and an external electronic device performing NAN communication and short-range wireless communication according to an embodiment;

FIG. 6 illustrates an electronic device according to an embodiment;

FIG. 7 illustrates schedule information for an electronic device performing NAN communication and communication via cross-connection, according to an embodiment;

FIG. 8 illustrates an example in which an electronic device activates cross-connection, according to an embodiment;

FIG. 9 illustrates an example in which an electronic device activates cross-connection, according to an embodiment;

FIG. 10 illustrates an example in which an electronic device activates cross-connection, according to an embodiment; and

FIG. 11 illustrates an operating method of an electronic device according to an embodiment.

### DETAILED DESCRIPTION

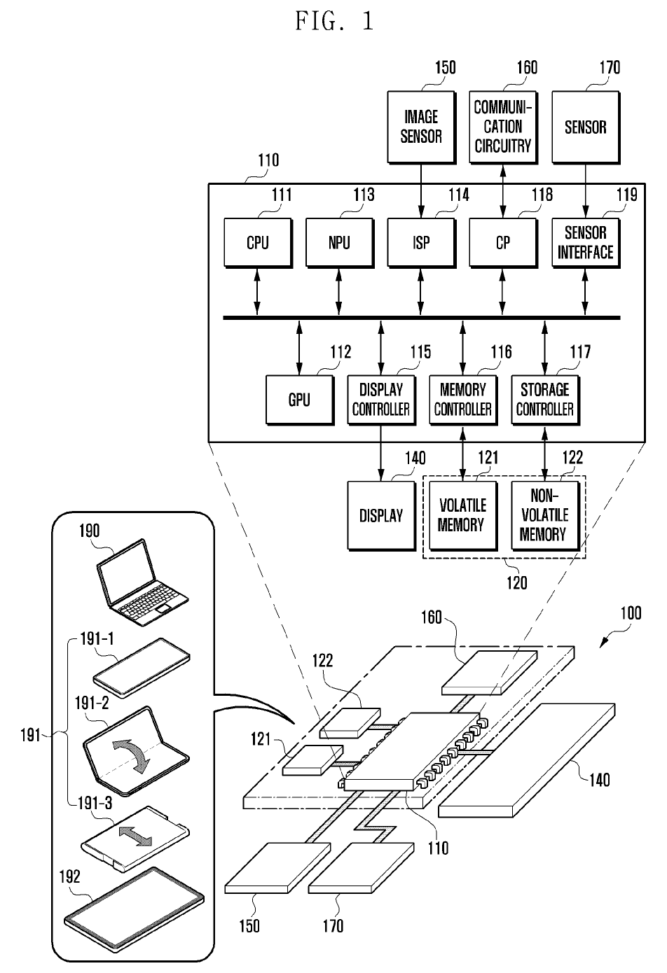

FIG. 1 illustrates a block diagram of an exemplary electronic device 100 capable of performing the operations described herein.

Referring to FIG. 1, the electronic device 100 may be one of various types of electronic devices, such as a notebook computer 190, smartphones 191 having various form factors (e.g., a bar-type smartphone 191-1, a foldable smartphone 191-2, or a slidable (or rollable) smartphone 191-3), a tablet PC 192, a cellular telephone, and any other similar computing devices. The components illustrated in FIG. 1, the relationships thereof, and the functions thereof are merely for illustration, and are not intended to limit the implementations described or claimed in the disclosure thereto. The electronic device 100 may be referred to as a mobile device, a user equipment, a multifunctional device, a portable device, or a server.

The electronic device 100 may comprise various components including at least one processor 110 (hereinafter, the processor 110), at least one memory 120 (hereinafter, the memory 120), at least one display 140 (hereinafter, the display 140), at least one image sensor 150 (hereinafter, the image sensor 150), at least one communication circuitry 160 (hereinafter, the communication circuitry 160), and/or at least one sensor 170 (hereinafter, the sensor 170). The aforementioned components are merely of an example. For example, the electronic device 100 may comprise other components (e.g., a power management integrated circuitry (PMIC), an audio processing circuitry, an antenna, a rechargeable battery, or an input/output interface). For example, some components may be omitted from the electronic device (100). For example, some components may be integrated into one component.

The processor 110 may be implemented as one or more integrated circuit (or circuitry) (IC) chips and may perform various data processing. The processor 110 may include at least one electrical circuitry and may process instructions (or program, data, and so on) stored in the memory 120 individually or collectively in a distributed manner. The processor 110 may include a processor assembly that includes one or more processing circuitries. The processor may include any processing circuitry that may be operative for controlling operations and performance of one or more components (e.g., the memory 120, a display 140, the image sensor 150, the communication circuitry 160, and/or the sensor 170) of the electronic device. For example, the processor 110 (e.g., an application processor (AP)) may be implemented as a system on chip (SoC) (e.g., one chip or chipset). For example, the processor 110 may be implemented as a plurality of cores (or at least one core circuitry), a plurality of chips, or a plurality of chipsets. For example, the processor 110 may comprise one or more processing circuitry. For example, the processor 110 may comprise one or more processing circuitry which are individually and/or collectively configured to perform various functions of the present disclosure. As a non-limiting example, at least a portion of the processor 110 may be included in a first chip of the electronic device 100 and at least another portion of the processor 110 may be included in a second chip of the electronic device 100 different from the first chip of the electronic device 100.

For example, the processor 110 may comprise a central processing unit (CPU) 111, a graphics processing unit (GPU) 112, a neural processing unit (NPU) 113, an image signal processor (ISP) 114, a display controller 115, a memory controller 116, a storage controller 117, a communication processor (CP) 118, and/or a sensor interface 119. These components of the processor 110 are merely of an example. For example, the processor 110 may further comprise other components. For example, some components of the processor 110 may be omitted from the processor 110. For example, some components of the processor 110 may be included as separate components of the electronic device 100 outside the processor 110. For example, some components of the processor 110 (e.g., the memory controller 116) may be included in other components of the electronic device 100 (e.g., at least a portion of the memory 120, an interface (e.g., usable for connecting to at least one component of the electronic device 100), the display 140, and/or the image sensor 150).

The processor 110 may cause other components of the electronic device 100 to perform various operations by executing instructions stored in the memory 120. The CPU 111 (or a central processing circuitry) may be configured to control the components of the processor 110 based on execution of instructions stored in the memory 120 (e.g., the volatile memory 121 and/or the non-volatile memory 122). The GPU 112 (or a graphic processing circuitry) may be configured to execute parallel computations (e.g., rendering). The NPU 113 (or a neural processing circuitry, or an artificial intelligence (AI) chip) may be configured to execute operations (e.g., convolution computations) for an artificial intelligence model. The ISP 114 (or an image signal processing circuitry) may be configured to process a raw image obtained from the image sensor 150 in a format suitable for a component in the electronic device 100 or a component of the processor 110. The display controller 115 (or a display control circuitry, or a display processing unit (DPU)) may be configured to process an image obtained from the CPU 111, the GPU 112, the ISP 114, or the memory 120 (e.g., the volatile memory 121) in a format suitable for the display 140. The memory controller 116 (or a memory control circuitry) may be configured to control reading data from the volatile memory 121 and writing data to the volatile memory 121. The storage controller 117 (or a storage control circuitry) may be configured to control reading data from the non-volatile memory 122 and writing data to the non-volatile memory 122. The CP 118 (or a communication processing circuitry) may be configured to process data obtained from a component of the processor 110 in a format suitable for transmission to another electronic device via the communication circuitry 160, or to process data obtained from another electronic device via the communication circuitry 160 in a format suitable for processing of the component of the processor 110. For example, the communication circuitry 160 may comprise one or more communication circuitry. The sensor interface 119 (or a sensing data processing circuitry, a sensor hub) may be configured to process data on a state of the electronic device 100 and/or a state around the electronic device 100, obtained through the sensor 170, in a format suitable for a component of the processor 110.

The memory 120 may comprise one or more storage mediums (or one or more storage devices). For example, the memory 120 may include a memory assembly that includes one or more storage mediums. For example, the one or more storage mediums may comprise a permanent memory (e.g., the non-volatile memory 122) such as a hard drive, a flash memory, a read-only memory (ROM), a semi-permanent memory (e.g., the volatile memory 121) such as a random access memory (RAM), a storage (or a storage assembly) of any other suitable type, or any combination thereof. The memory 120 may comprise a cache memory which is a memory of one or more different types used to store data for performing a function or feature of the electronic device 100 at least temporarily. As a non-limiting example, the cache memory may be included in the processor 110. The memory 120 may be fixedly embedded within the electronic device 100, or may be incorporated onto one or more suitable types of components that may be repeatedly inserted into the electronic device 100, and removed from the electronic device 100 (e.g., a subscriber identity module (SIM) card, and/or a secure digital (SD) card).

For example, the memory 120 may store one or more software applications such as an operating system (or a system) software application, a firmware software application, a driver software application, a plug-in (e.g., add-in, add-on, and/or applet) software application, and/or any other suitable software application. For example, the one or more software applications may include instructions executable by the processor 110. For example, the memory 120 may store instructions callable by an application programming interface (API). For example, the memory 120 may store instructions in a library.

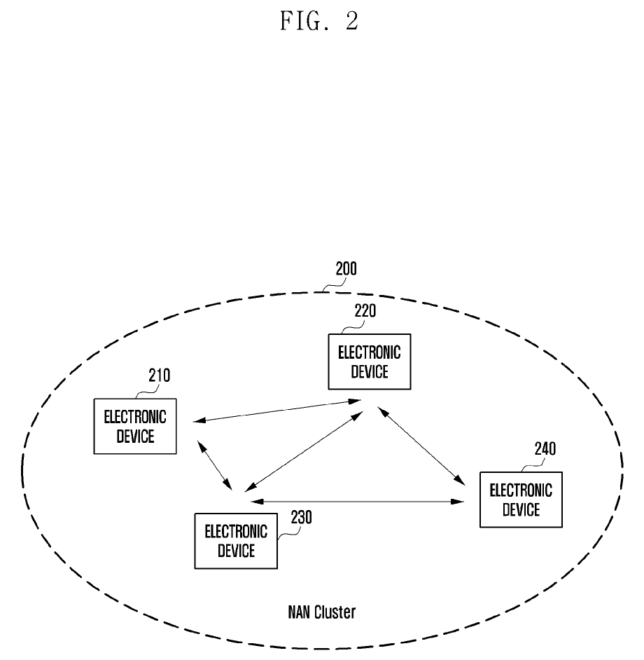

FIG. 2 illustrates a neighbor awareness network (NAN) cluster according to one or more embodiments.

For example, FIG. 2 may illustrate an example configuration of a neighbor awareness networking (NAN) cluster 200 for a proximity network according to one or more embodiments. In the following description, the cluster 200 may refer to a set of electronic devices 210, 220, 230, and 240 that constitute a proximity network so that the respective electronic devices (or NAN devices) 210, 220, 230, and 240 (e.g., the electronic device 100 in FIG. 1) may transmit and receive data to and from each other. For example, the cluster 200 may be referred to as an NAN cluster in accordance with an NAN specification (or standard).

With reference to FIG. 2, the cluster 200 may include a plurality of electronic devices 210, 220, 230, and 240. The electronic devices 210, 220, 230, and 240 included in the cluster 200 may transmit and receive a beacon (or discovery beacon) and/or a service discovery frame (SDF) (“SDF”) within a synchronized time duration (or communication period) (e.g., a discovery window (DW)).

The electronic devices 210, 220, 230, and 240 included in the cluster 200 may have their time clocks synchronized with each other. For example, the electronic devices 210, 220, 230, and 240 may be synchronized to the time clock of one electronic device (e.g., the electronic device 210) and exchange beacons and SDFs with each other in the same discovery window.

According to an embodiment, an electronic device that supports a low-power short-range communication technology based on NAN may broadcast a discovery signal (e.g., a beacon) to discover another electronic device every preconfigured first period (e.g., about 100msec) and perform scanning every preconfigured second period (e.g., about 10msec) to receive a discovery signal broadcast from another electronic device.

The electronic device 210, 220, 230, or 240 may detect at least one other electronic device located nearby, based on the discovery signal received through scanning, and perform NAN cluster synchronization with the detected at least one other electronic device. The NAN cluster synchronization may include an operation of receiving time clock information of an electronic device representing an NAN cluster so that electronic devices included in the NAN cluster transmit and/or receive data on the same channel and/or during the same time.

For example, as illustrated in FIG. 2, each of the plurality of electronic devices 210, 220, 230, and 240 may transmit and receive a beacon to and from other electronic devices 210, 220, 230, and 240, thereby forming the cluster 200 that operates according to a synchronized time clock, and the electronic devices 210, 220, 230, and 240 within the cluster 200 may perform NAN cluster synchronization.

The NAN cluster synchronization may be performed based on the time and channel of the electronic device with the highest master preference within the cluster 200. For example, the electronic devices 210, 220, 230, and 240 within the cluster 200 formed through discovery may exchange signals regarding master preference information indicating a preference for operating as an anchor master, and the electronic device with the highest master preference may be determined as the anchor master (or master electronic device) through the exchanged signals.

The anchor master may refer to an electronic device that serves as a reference for time and channel synchronization of the electronic devices 210, 220, 230, and 240 within the cluster 200. The anchor master may be changed according to the master preference of the electronic devices. Each of the time and channel synchronized electronic devices 210, 220, 230, and 240 may transmit a beacon and an SDF and receive beacons and SDFs from other electronic devices in the cluster 200 within a discovery window (or a discovery period) that is repeated according to a preconfigured cycle. According to an embodiment, the beacon may be periodically transmitted and received for each discovery window so that the time and channel synchronization of the electronic devices 210, 220, 230, and 240 in the cluster 200 is continuously maintained. The SDF may be transmitted and received during the discovery window as needed so that services with the discovered electronic devices 210, 220, 230, and 240 are provided. According to an embodiment, the electronic device operating as the anchor master among the time and channel synchronized electronic devices 210, 220, 230, and 240 may transmit a beacon to detect a new electronic device during the period between the discovery windows.

Each of the electronic devices 210, 220, 230, and 240 in the cluster 200 may operate in an active state only during the discovery window and operate in a low-power state (e.g., sleep state) during the remaining period other than the discovery window, thereby reducing current consumption.

For example, the discovery window is a period of time (e.g., milliseconds) during which an electronic device is active (or awake) and consumes a lot of current, whereas the period other than the discovery window allows low-power discovery because the electronic device remains in a sleep state.

The electronic devices 210, 220, 230, and 240 in the cluster 200 may be simultaneously activated at the start time (e.g., DW start) of the synchronized discovery window and simultaneously switched to a sleep state at the end time (e.g., DW end) of the discovery window.

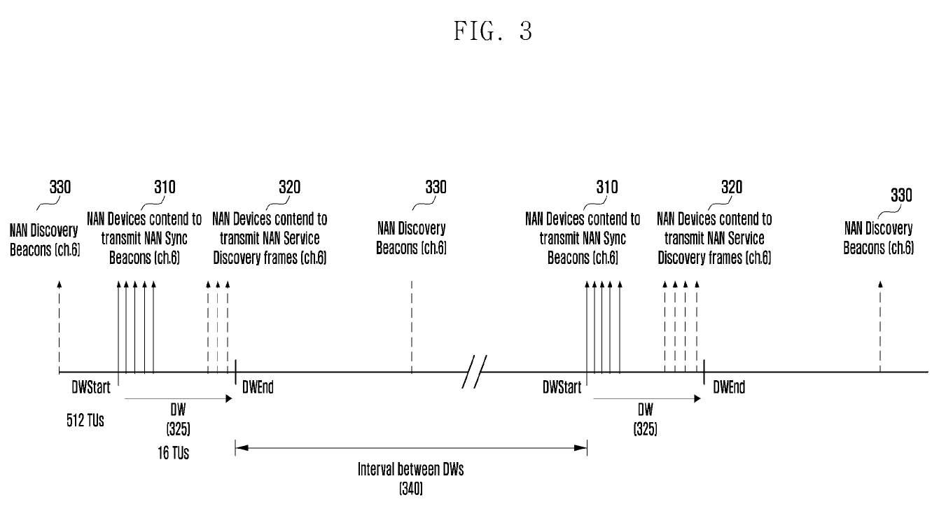

The electronic devices 210, 220, 230, and 240 included in the cluster 200 may perform discovery, synchronization, and data exchange operations, using a protocol illustrated in FIG. 3 described below.

FIG. 3 illustrates a protocol for transmitting a signal of an electronic device included in an NAN cluster according to one or more embodiments of the disclosure.

For example, FIG. 3 may illustrate an example of a discovery window according to one or more embodiments. In an exemplary illustration of FIG. 3, electronic devices included in a single cluster transmit signals through a specific channel (e.g., channel 6 (Ch6)) based on an NAN standard.

With reference to FIG. 3, the electronic devices included in one cluster may transmit synchronization beacons 310 and SDFs 320 in a synchronized discovery window (DW) 325. In a period 340 other than the discovery window 325 (e.g., a period between the discovery windows), at least one electronic device may transmit a discovery beacon 330. According to an embodiment, the electronic devices may transmit the synchronization beacons 310 and the SDFs 320, based on contention. For example, the synchronization beacons 310 and the SDFs 320 may be transmitted based on contention among the respective electronic devices belonging to the cluster.

The discovery window 325 may be a period during which the electronic devices are activated from a sleep state, which is a power saving mode, to a wake-up state for data exchange between the electronic devices. For example, the discovery window 325 may be distinguished by a time unit (TU) in milliseconds. According to an embodiment, the discovery window 325 for transmission/reception of the synchronization beacons 310 and the SDFs 320 may occupy 16 time units (16 TUs) and may have a cycle (or period) that repeats as 512 time units (512 TUs).

The discovery beacon 330 may indicate a signal transmitted so that any other electronic device that has not joined the cluster may discover the cluster. For example, the discovery beacon 330 is a signal for notifying the cluster’s presence, and electronic devices that do not participate in the cluster may perform a passive scan to receive the discovery beacon 330 and thereby discover and join the cluster.

The discovery beacon 330 may contain information necessary for synchronization with the cluster. For example, the discovery beacon 330 may include at least one of a frame control (FC) field indicating a function of a signal (e.g., a beacon), a broadcast address, a media access control (MAC) address of a transmitting electronic device, a cluster identifier (ID), a sequence control field, a time stamp for a beacon frame, a beacon period indicating a transmission period of the discovery beacon 330, or capability information on an electronic device transmitting the discovery beacon 330.

The discovery beacon 330 may include at least one proximity network (or cluster) related information element. In an embodiment, the proximity network related information may be referred to as attribute information.

The synchronization beacon 310 may indicate a signal for maintaining synchronization between the synchronized electronic devices in the cluster. The synchronization beacon 310 may be transmitted by a synchronization device among the electronic devices in the cluster. For example, the synchronization device may include an anchor master device, a master device, or a non-master sync device, which is defined in the NAN standard.

The synchronization beacon 310 may include information necessary for the electronic devices to synchronize within the cluster. For example, the synchronization beacon 310 may include at least one of an FC field indicating a function of a signal (e.g., a beacon), a broadcast address, a MAC address of a transmitting electronic device, a cluster identifier, a sequence control field, a time stamp for a beacon frame, a beacon period indicating a period between start points of the discovery windows 325, or capability information on the transmitting electronic device. According to an embodiment, the synchronization beacon 310 may include at least one proximity network (or cluster) related information element. For example, the proximity network related information may include contents for a service provided via the proximity network.

The SDF 320 may indicate a signal for exchanging data via the proximity network. According to an embodiment, the SDF 320 represents a vendor specific public action frame and may include various fields. For example, the SDF 320 may include a category or action field and may include at least one proximity network related information.

The synchronization beacon 310, the SDF 320, and the discovery beacon 330 may include proximity network related information. In an embodiment, the proximity network related information may include an identifier indicating a type of information, a length of information, and a body field which is corresponding information. In an embodiment, the corresponding information may include at least one of master indication information, cluster information, service identifier list information, service descriptor information, connectivity capability information, wireless LAN infrastructure information, peer-to-peer (P2P) operation information, independent basic service set (IBSS) information, mesh information, additional proximity network service discovery information, further availability map information, country code information, ranging information, cluster discovery information, or vendor specific information.

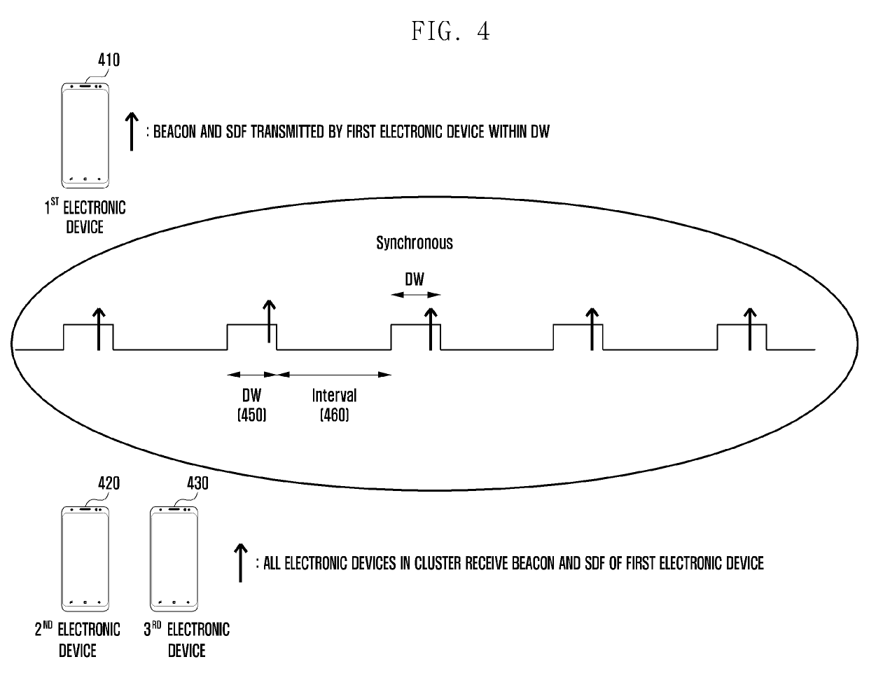

FIG. 4 illustrates an example of data transmission and reception within an NAN cluster according to one or more embodiments of the disclosure.

For example, FIG. 4 illustrates an example in which a first electronic device 410, a second electronic device 420, and a third electronic device 430 form a single cluster through wireless short-range communication technology, and the respective electronic devices 410, 420, and 430 may transmit and receive a beacon and/or an SDF to and from each other. According to an embodiment, FIG. 4 illustrates an example in which the first electronic device 410 among the electronic devices 410, 420, and 430 constituting the cluster performs the role of a master electronic device.

With reference to FIG. 4, the first electronic device 410 may transmit the beacon and the SDF within a discovery window 450. The first electronic device 410 may broadcast the beacon and the SDF every discovery window 450 that is repeated according to a preconfigured period (e.g., period 460).

The second electronic device 420 and the third electronic device 430 may receive the beacon and the SDF transmitted by the first electronic device 410. According to an embodiment, each of the second electronic device 420 and the third electronic device 430 may receive the beacon and the SDF broadcast from the first electronic device 410 every discovery window 450.

The beacon transmitted within the discovery window 450 may include a synchronization beacon and may include information for maintaining synchronization among the electronic devices 410, 420 and 430. For example, the second electronic device 420 and/or the third electronic device 430 may perform NAN cluster synchronization, based on time clock information of the first electronic device 410 included in the beacon transmitted by the first electronic device 410 operating as a master. The second electronic device 420 and/or the third electronic device 430 may be synchronized, and thereby the discovery window 450 may be activated at the same time.

In a period (e.g., the period 460) other than the discovery window 450, the electronic devices 410, 420, and 430 may maintain a sleep state to reduce current consumption. For example, the electronic devices 410, 420, and 430 may reduce current consumption by operating in a wake state only during the discovery window 450, based on a synchronized time clock.

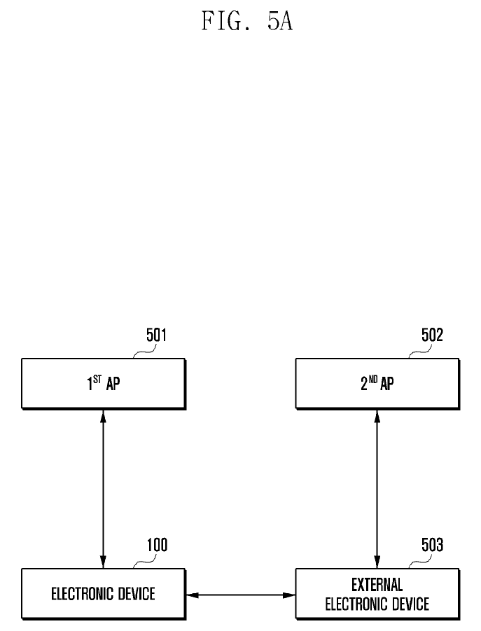

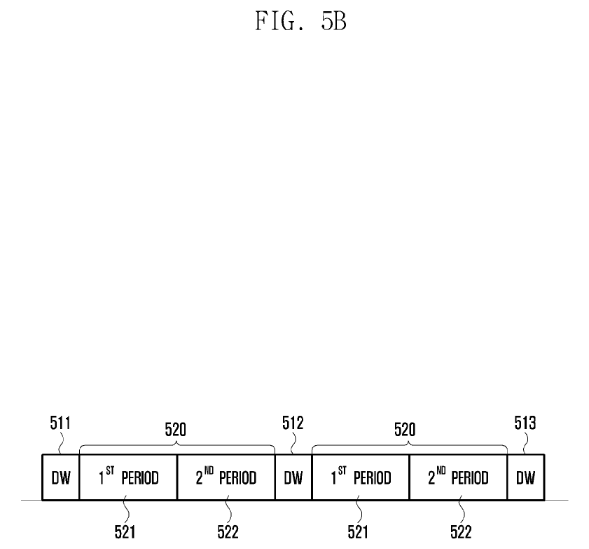

FIG. 5A illustrates an electronic device and an external electronic device according to an embodiment.

An electronic device 100 (e.g., the electronic device 100 in FIG. 1, the electronic device 410, 420, or 430 in FIG. 4) and an external electronic device 503 (e.g., the electronic device 100 in FIG. 1, the electronic device 410, 420, or 430 in FIG. 4) may be included in the same NAN cluster (e.g., the NAN cluster 200 in FIG. 2).

The electronic device 100 may be connected to a first AP 501 via short-range wireless communication. The first AP 501 may be an entity that performs the role of an access point defined in IEEE 802.11. The first AP 501 may transmit data, transmitted by the electronic device 100 via short-range wireless communication, to the outside, and may transmit data, received from the outside, to the electronic device 100 via short-range wireless communication.

The electronic device 100 may transmit and/or receive data to and/or from the external electronic device 503 via NAN communication, and may transmit and/or receive data to and/or from the first AP 501 via short-range wireless communication.

The external electronic device 503 may be connected to a second AP 502 via short-range wireless communication. The second AP 502 may be an entity that performs the role of an access point defined in IEEE 802.11. The second AP 502 may transmit data, transmitted by the external electronic device 503 via short-range wireless communication, to the outside, and may transmit data, received from the outside, to the external electronic device 503 via short-range wireless communication.

The external electronic device 503 may transmit and/or receive data to and/or from the electronic device 501 via NAN communication, and may transmit and/or receive data to and/or from the second AP 502 via short-range wireless communication.

The electronic device 100 and the external electronic device 503 may perform NAN communication and/or short-range wireless communication even in a period other than the discovery window 450. In an example, the electronic device 100 and the external electronic device 503 may not complete data transmission and/or reception during the discovery window 450. In an example, if the size of the data is so large that the transmission and/or reception cannot be completed during the discovery window 450, the electronic device 100 and the external electronic device 503 may fail to complete data transmission and/or reception during the discovery window 450. The electronic device 100 and the external electronic device 503 may perform data transmission and/or reception through NAN communication by enabling the data transmission and/or reception to be performed during the period between the discovery windows 450.

However, since the electronic device 100 and the external electronic device 503 have to perform short-range wireless communication in addition to NAN communication, an appropriate schedule may be required to perform both short-range wireless communication and NAN communication. Specific details regarding the schedule are described later in FIG. 5B.

FIG. 5B illustrates an example of an electronic device and an external electronic device performing NAN communication and short-range wireless communication according to an embodiment.

An electronic device (e.g., the electronic device 100 in FIG. 5A) and an external electronic device (e.g., the external electronic device 503 in FIG. 5A) may perform NAN communication and/or short-range wireless communication even during a period other than the discovery window 450. According to an example, the electronic device 100 and the external electronic device 503 may fail to complete data transmission and/or reception during the discovery window 450. According to an example, if the size of the data is so large that transmission and/or reception cannot be completed during the discovery window 450, the electronic device 100 and the external electronic device 503 may not complete data transmission and/or reception during the discovery window 450.

The electronic device 100 and the external electronic device 503 may perform an operation for performing NAN communication during a first period 521, which is at least a portion of a period 520 between discovery windows 511, 512, and 513 (e.g., the discovery window 450 in FIG. 4). For example, the electronic device 100 and the external electronic device 503 may be configured to exchange configuration information (e.g., NAN availability attribute or ‘further available window’ (FAW) attribute) for performing NAN communication during a second period 522, which is at least a portion of the period 520 between the discovery windows 511, 512, and 513, and perform NAN communication during the second period 522 through negotiation. The second period 522 may be referred to as the further available window (FAW), considering that it is an additional period during which NAN communication is possible, other than the discovery windows 511, 512, and 513 defined in the NAN cluster.

The electronic device 100 and the external electronic device 503 may configure a schedule to perform short-range wireless communication during at least a portion (e.g., the first period 521) of a period between the discovery windows 511, 512, and 513, using an AP (e.g., the first AP 501 or the second AP 502).

The electronic device 100 and the external electronic device 503 may perform short-range wireless communication (e.g., Wi-Fi, Wi-Fi direct, and/or Hotspot) during the first period 521 that is another period excluding the second period 522 from the period 520 between the discovery windows 511, 512, and 513. For example, the electronic device 100 and the external electronic device 503 may perform a series of operations for performing short-range wireless communication other than NAN communication during the first period 521 that is at least a portion of the period 520 between the discovery windows 511, 512, and 513. The first period 521 may be at least a portion of the period excluding the discovery windows 511, 512, and 513 and the second period 522 defined in the NAN cluster.

The first period 521 may be referred to as an ‘unaligned window’ (ULW), considering the characteristic of performing short-range wireless communication rather than NAN communication during a period between the discovery windows 511, 512, and 513.

A channel (or frequency band) between the electronic device 100 and the first AP 501 may be different from a channel (or frequency band) between the external electronic device 503 and the second AP 502. If the channel (or frequency band) between the electronic device 100 and the first AP 501 and the channel (or frequency band) between the external electronic device 503 and the second AP 502 are different from each other, the electronic device 100 and the external electronic device 503 cannot perform NAN communication during the first period 521. For example, the electronic device 100 may fail to simultaneously perform data transmission and/or reception using a plurality of channels, and while performing data transmission and/or reception via a channel between the electronic device 100 and the first AP 501 during the first period 521, fail to perform NAN communication via another channel. The external electronic device 503 may fail to simultaneously perform data transmission and/or reception using a plurality of channels, and while performing data transmission and/or reception via a channel between the external electronic device 503 and the second AP 502 during the first period 521, fail to perform NAN communication via another channel.

Therefore, the electronic device 100 and the external electronic device 503 may perform an operation of configuring not to perform NAN communication during the first period 521 in order to perform short-range wireless communication during the first period 521. The electronic device 100 and the external electronic device 503 may exchange configuration information (e.g., unaligned schedule attribute) for performing short-range wireless communication (or configuration information not to perform NAN communication) during the first period 521, which is at least a portion of the period 520 between the discovery windows 521 and 522, and configure not to perform NAN communication during the first period 521 (or to perform short-range wireless communication during the first period 521) through negotiation using the configuration information. The configuration information for performing short-range wireless communication may include at least one of information indicating a frequency band (e.g., 2.4 GHz, 5 GHz, 6 GHz) of short-range wireless communication performed in the first period 521, channel information of short-range wireless communication performed in the first period 521, a starting time point of the first period 521 (e.g., a starting time field of the unaligned schedule attribute), a duration of the first period 521 (e.g., a duration field of the unaligned schedule attribute), and a period of the first period 521 (e.g., a period field of the unaligned schedule attribute).

An electronic device willing to perform short-range wireless communication in the first period 521 of the period 520 between the discovery windows 511, 512, and 513 may transmit information configuring not to perform NAN communication in the first period 521 (or information to perform short-range wireless communication in the first period 521) to an electronic device included in the NAN cluster, and be configured to perform short-range wireless communication in the first period 521.

With reference to the schedule illustrated in FIG. 5B, the electronic device 100 and the external electronic device 503 are configured to perform short-range wireless communication during the first period 521, and cannot perform NAN communication during the first period 521. If NAN communication cannot be performed during the first period 521, the quality of a service using NAN communication may deteriorate. According to an example, if the service using NAN communication is a service requiring low latency (e.g., screen mirroring or multi-device service), the inability to perform NAN communication during the first period 521 may lead to a degradation in service quality.

The above-described problem may occur because the channel (or frequency band) between the electronic device 100 and the first AP 501 is different from the channel (or frequency band) between the external electronic device 503 and the second AP 502, and thus, NAN communication cannot be performed during the first period 521. Hereinafter, examples will be described in which the electronic device 100 may solve the above-described problem by enabling the electronic device 100 and the external electronic device 503 to perform both NAN communication and short-range wireless communication during the first period 521.

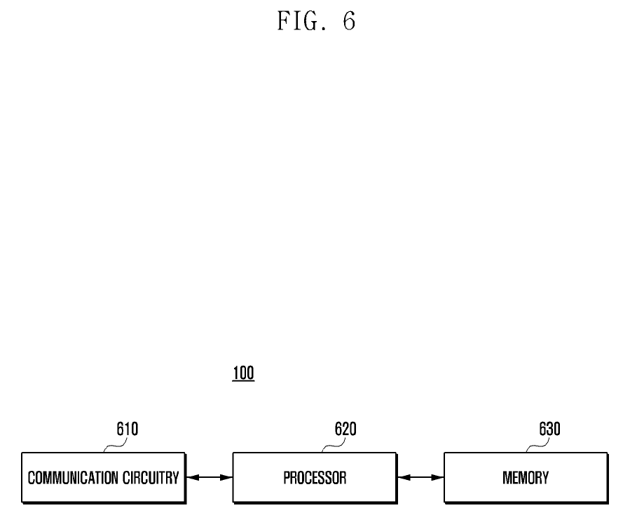

FIG. 6 illustrates an electronic device according to an embodiment.

According to an embodiment, an electronic device (e.g., the electronic device 100 in FIG. 5A) may include communication circuitry 610 (e.g., the communication circuitry 160 in FIG. 1), a processor 620 (e.g., the processor 110 in FIG. 1), and/or a memory 630.

The communication circuitry 610 may support neighbor awareness network (NAN) communication and peer-to-peer (P2P) communication different from the NAN communication. The P2P communication different from the NAN communication may refer to communication capable of performing direct communication between electronic devices without going through an AP. According to an example, the P2P communication may include Wi-Fi direct.

The communication circuitry 610 may include various circuitry structures used for modulating and/or demodulating signals within the electronic device 100. For example, the communication circuitry 610 may modulate a baseband signal into a radio frequency (RF) band signal to be output through an antenna, or demodulate an RF band signal received through an antenna into a baseband signal and transmit it to the processor 620.

The processor 620 may perform an operation of receiving data transmitted by an application processor (e.g., the processor 120 in FIG. 1) and generating a packet to transmit the received data. The processor 620 may be defined as a communication processor or an application processor included in a communication module (e.g., the wireless communication module 192 in FIG. 1). The processor 620 may be electrically or operatively connected to the communication circuitry 610 and control the communication circuitry 610.

The memory 630 may store instructions that may be executed by the processor 620. The operation of the processor 620 described below may be performed according to the execution of instructions stored in the memory 630.

The processor 620 may activate NAN communication. According to an example, the processor 620 may activate NAN communication when data transmission and/or reception via NAN communication is required, when a service or application related to data transmission and/or reception via NAN communication is activated, and/or when a user input for performing data transmission and/or reception via NAN communication is received.

The processor 620 may activate NAN communication in a state where short-range wireless communication is activated. Alternatively, the processor 620 may activate short-range wireless communication and NAN communication at substantially the same time. The processor 620 may be connected to a first AP (e.g., the first AP 501 in FIG. 5A) via short-range wireless communication and transmit and/or receive data to and/or from the first AP 501.

The processor 620 may discover an electronic device (e.g., the external electronic device 503 in FIG. 5A) capable of performing NAN communication, as a part of an operation of activating NAN communication. The processor 620 may control the communication circuitry 610 to transmit a service discovery frame to the external electronic device 503.

The service discovery frame may include information related to negotiation for activating NAN communication between the electronic device 100 and the external electronic device 503. According to an example, the service discovery frame may include information of the electronic device 100, performance information of the electronic device 100 (e.g., NAN communication related performance information of the electronic device 100), and/or identification information of a service related to NAN communication.

The service discovery frame may include information of the first AP 501 connected to the electronic device 100 via short-range wireless communication. The information of the first AP 501 may include information on a channel between the first AP 501 and the electronic device 100 (e.g., a channel number, a frequency band of the channel, and/or a bandwidth of the channel), and performance information of the first AP 501 (e.g., a function related to short-range wireless communication supported by the first AP 501, a version of Wi-Fi supported by the first AP 501, and/or the number of antennas included in the first AP 501).

The service discovery frame may include information indicating whether the electronic device 100 supports a cross-connection function which is a function capable of providing short-range wireless communication to the external electronic device 503.

The cross-connection function may refer to a function in which the external electronic device 503 is connected to the first AP 501 via the electronic device 100. The external electronic device 503 may be connected to the first AP 501 through an NAN data path (NDP) established (or configured) between the external electronic device 503 and the electronic device 100. Since the cross-connection function may operate based on the NDP, the electronic device 100 and the external electronic device 503 may simultaneously perform NAN communication while performing the cross-connection function. The external electronic device 503 performing the cross-connection function may transmit data to the first AP 501 through the electronic device 100 via the NDP activated during at least a portion of a period between discovery windows (e.g., the discovery windows 450 in FIG. 4) and receive data, transmitted by the first AP 501, from the electronic device 100 via the NDP.

Since the cross-connection function may operate based on the NDP, the electronic device 100 and the external electronic device 503 may perform NAN communication together while exchanging data through the cross-connection function.

According to an example, the service discovery frame may include information on the first AP 501 connected to the electronic device 100 via short-range wireless communication and/or information indicating whether the electronic device 100 supports the cross-connection function.

The processor 620 may receive the service discovery frame from the external electronic device 503 in the process of discovering an electronic device (e.g., the external electronic device 503 in FIG. 5A) capable of performing NAN communication.

The service discovery frame may include information of the external electronic device 503, performance information of the external electronic device 503 (e.g., NAN communication related performance information of the external electronic device 503), and/or identification information of a service related to NAN communication.

The service discovery frame may include information of the second AP 502 connected to the external electronic device 503 via short-range wireless communication. The information of the second AP 502 may include information on a channel between the second AP 502 and the external electronic device 503 (e.g., a channel number, a frequency band of the channel, and/or a bandwidth of the channel), performance information of the second AP 502 (e.g., a function related to short-range wireless communication supported by the second AP 502, a version of Wi-Fi supported by the second AP 502, and/or the number of antennas included in the second AP 502).

The service discovery frame may include information indicating whether the external electronic device 503 supports a cross-connection function which is a function capable of providing short-range wireless communication to the electronic device 100. The cross-connection function may refer to a function in which the electronic device 100 is connected to the second AP 502 via the external electronic device 503. The external electronic device 503 supporting the cross-connection function may transmit data, received from the second AP 502, to the electronic device 100 and transmit data, transmitted by the electronic device 100, to the second AP 502.

According to an example, the service discovery frame may include information of the second AP 502 connected to the external electronic device 503 via short-range wireless communication and/or information indicating whether the external electronic device 503 supports the cross-connection function.

The processor 620 may activate the cross-connection function, based on the service discovery frame transmitted by the external electronic device 503.

According to an example, the processor 620 may identify the service discovery frame transmitted by the external electronic device 503 and identify channel information between the external electronic device 503 and the second AP 502. The processor 620 may activate the cross-connection function, based on identifying that the channel between the external electronic device 503 and the second AP 502 is different from the channel between the electronic device 100 and the first AP 501.

According to an example, the processor 620 may also activate the cross-connection function, based on identifying the service discovery frame transmitted by the external electronic device 503 and identifying that the external electronic device 503 is connected to the second AP 502.

The processor 620 may determine a device to provide the cross-connection function (or a subject performing the cross-connection function), as a part of the operation of activating the cross-connection function. The device to provide the cross-connection function (or the subject performing the cross-connection function) may refer to a device that provides short-range wireless communication to a counterpart electronic device. The device to provide the cross-connection function may maintain a connection (or short-range wireless communication) with an AP and transmit data, transmitted by the counterpart electronic device, to the AP via short-range wireless communication. The device to provide the cross-connection function may be referred to as an owner or a master.

The processor 620 may determine the device to provide the cross-connection function, based on the performance of the first AP 501 and/or the performance of the second AP 502.

According to an example, if the first AP 501 supports short-range wireless communication using a higher frequency band, the processor 620 may select (or determine) the electronic device 100 connected to the first AP 501 as the device to provide the cross-connection function.

According to an example, if the second AP 502 supports short-range wireless communication using a higher frequency band, the processor 620 may select (or determine) the external electronic device 503 connected to the second AP 502 as the device to provide the cross-connection function.

According to an example, if the first AP 501 supports short-range wireless communication using a channel with a larger frequency bandwidth, the processor 620 may select (or determine) the electronic device 100 connected to the first AP 501 as the device to provide the cross-connection function.

According to an example, if the second AP 502 supports short-range wireless communication using a channel with a larger frequency bandwidth, the processor 620 may select (or determine) the external electronic device 503 connected to the second AP 502 as the device to provide the cross-connection function.

According to an example, if the first AP 501 supports a higher version of short-range wireless communication (e.g., Wi-Fi 7), the processor 620 may select (or determine) the electronic device 100 connected to the first AP 501 as the device to provide the cross-connection function.

According to an example, if the second AP 502 supports a higher version of short-range wireless communication (e.g., Wi-Fi 7), the processor 620 may select (or determine) the external electronic device 503 connected to the second AP 502 as the device to provide the cross-connection function.

According to an example, if the first AP 501 supports a modulation scheme using a higher modulation coding scheme (MCS), the processor 620 may select (or determine) the electronic device 100 connected to the first AP 501 as the device to provide the cross-connection function.

According to an example, if the second AP 502 supports a modulation scheme using a higher MCS, the processor 620 may select (or determine) the external electronic device 503 connected to the second AP 502 as the device to provide the cross-connection function.

When determining the device to provide the cross-connection function, the processor 620 may compare a value (intent), configured by the electronic device 100, indicating the possibility that the electronic device 100 will provide the cross-connection function and a value, configured by the external electronic device 503, indicating the possibility that the external electronic device 503 will provide the cross-connection function. The value, configured by the external electronic device 503, indicating the possibility that the external electronic device 503 will provide the cross-connection function may be included in the service discovery frame transmitted by the external electronic device 503. The processor 620 may determine, as the electronic device to provide the cross-connection function, an electronic device that configures a higher value between the value (intent) indicating the possibility that the electronic device 100 will provide the cross-connection function and the value, configured by the external electronic device 503, indicating the possibility that the external electronic device 503 will provide the cross-connection function.

The examples described above are described as examples for selecting the electronic device to provide the cross-connection function, and in addition to above-described examples, various kinds of information may be considered to determine (or select) the electronic device to provide the cross-connection function.

In the case of determining (or selecting) the electronic device 100 as the electronic device to provide the cross-connection function, the processor 620 may control the communication circuitry 610 to transmit the service discovery frame including information indicating the electronic device (e.g., the electronic device 100) to provide the cross-connection function to the external electronic device 503. Upon receiving the service discovery frame including information indicating the electronic device (e.g., the electronic device 100) to provide the cross-connection function, the external electronic device 503 may release the connection via short-range wireless communication between the external electronic device 503 and the second AP 502.

In the process of configuring NAN communication between the electronic device 100 and the external electronic device 503, the processor 620 may conFIGURE(or generate) schedule information related to performing NAN communication and performing communication using the cross-connection function.

The processor 620 may conFIGURE(or generate) schedule information to perform communication using the cross-connection function during at least a portion of the period between the discovery windows 450. The processor 620 may conFIGURE(or generate) schedule information to perform NAN communication during another portion of the period between the discovery windows 450.

According to an example, in a section, configured to perform communication using the cross-connection function, of the period between the discovery windows 450, a channel of an NDP established between the electronic device 100 and the external electronic device 503 may be the same as a channel established between the electronic device 100 and the first AP 501. The electronic device 100 may configure schedule information to perform NAN communication using the same channel as the channel established between the electronic device 100 and the first AP 501, and the electronic device 100 may simultaneously perform short-range wireless communication between the first AP 501 and the electronic device 100 and NAN communication between the electronic device 100 and the external electronic device 503 in the section, configured to perform communication using the cross-connection function, of the period between the discovery windows 450.

According to an example, in a section, configured to perform NAN communication, of the period between the discovery windows 450, a channel of an NDP established between the electronic device 100 and the external electronic device 503 may be the same as a channel configured in an NAN cluster (e.g., the NAN cluster 200 in FIG. 2) including the electronic device 100 and the external electronic device 503. Alternatively, in a section, configured to perform NAN communication, of the period between the discovery windows 450, a channel of an NDP established between the electronic device 100 and the external electronic device 503 may be different from a channel established between the electronic device 100 and the first AP 501. The electronic device 100 may perform NAN communication with the external electronic device 503 in the section, configured to perform NAN communication, of the period between the discovery windows 450. The electronic device 100 may not perform short-range wireless communication between the first AP 501 and the electronic device 100 in the section, configured to perform NAN communication, of the period between the discovery windows 450.

Based on the above-described scheme, through the cross-connection function, the electronic device 100 and the external electronic device 503 may perform NAN communication during the period between the discovery windows 450 and also perform both NAN communication and communication using the cross-connection function during at least a portion of the period between the discovery windows 450.

According to an example, in the section, configured to perform NAN communication, of the period between the discovery windows 450, the channel of the NDP established between the electronic device 100 and the external electronic device 503 may be configured to be identical to the channel established between the electronic device 100 and the first AP 501. That is, in the section between the discovery windows 450, the channel established between the electronic device 100 and the external electronic device 503 may be configured to be identical to the channel established between the electronic device 100 and the first AP 501. Therefore, the electronic device 100 may simultaneously perform short-range wireless communication between the first AP 501 and the electronic device 100 and NAN communication between the electronic device 100 and the external electronic device 503 during, of the period between the discovery windows 450, both the section configured to perform communication using the cross-connection function and the section configured to perform NAN communication.

According to an example, an NDP configured in the section configured to perform NAN communication, of the period between the discovery windows 450, and an NDP configured to perform communication using the cross-connection function in the period between the discovery windows 450 may be the same NDP. In this case, identification information of the NDP configured in the section configured to perform NAN communication, of the period between the discovery windows 450, may be the same as identification information of the NDP configured to perform communication using the cross-connection function in the period between the discovery windows 450.

According to an example, the first NDP (configured in the section configured to perform NAN communication) of the period between the discovery windows 450, and the second NDP configured to perform communication using the cross-connection function in the period between the discovery windows 450 may be different NDPs. According to an example, the processor 620 may establish (or configure) the first NDP to perform NAN communication with the external electronic device 503 before activating the cross-connection function. After establishing (or configuring) the first NDP to perform NAN communication with the external electronic device 503, the processor 620 may establish (or configure) the second NDP to perform communication using the cross-connection function according as the cross-connection function is activated. In this case, identification information of the first NDP configured in the section configured to perform NAN communication, of the period between the discovery windows 450, may be different from identification information of the second NDP configured to perform communication using the cross-connection function in the period between the discovery windows 450. The schedule information of the first NDP may enable the electronic device 100 and the external electronic device 503 to perform NAN communication via the first NDP during the period between the discovery windows 450 or at least a portion of the period between the discovery windows 450. The schedule information of the second NDP may enable the electronic device 100 and the external electronic device 503 to perform both NAN communication and communication using the cross-connection function together via the second NDP during a section, other than the period during which the electronic device 100 and the external electronic device 503 perform NAN communication via the first NDP, of the period between the discovery windows 450.

The above-described examples relate to the case where the electronic device 100 is selected as an electronic device providing the cross-connection function. However, the electronic device 100 may also be provided with the cross-connection function as described above.

In the case where the electronic device 100 is provided with the cross-connection function from the external electronic device 503, the processor 620 may receive, from the external electronic device 503, the schedule information that allows (or that is used by) the electronic device 100 and the external electronic device 503 to perform NAN communication during the period between the discovery windows 450 and to perform both NAN communication and communication using the cross-connection function simultaneously during at least a portion of the period between the discovery windows 450. Upon receiving the schedule information, the processor 620 may release the connection through short-range wireless communication with the first AP 501. Based on the schedule information, the processor 620 may control the communication circuitry 610 to perform NAN communication during the period between the discovery windows 450 and perform both NAN communication and communication using the cross-connection function during at least a portion of the period between the discovery windows 450. When performing the communication using the cross-connection function, the processor 620 may control the communication circuitry 610 to transmit data to the external electronic device 503 via an NDP. The external electronic device 503 may transmit data, received via the NDP, to the second AP 502 via short-range wireless communication. A channel corresponding to the NDP used while the cross-connection function is performed and a channel established between the external electronic device 503 and the second AP 502 may be the same channel.

The channel of the NDP, which is used while the electronic device 100 and the external electronic device 503 perform NAN communication, may be different from the channel established between the external electronic device 503 and the second AP 502. For example, the channel of the NDP used while the electronic device 100 and the external electronic device 503 perform NAN communication may be the same as the channel of the NAN cluster including the electronic device 100 and the external electronic device 503. Therefore, in the case of using the NDP used while the electronic device 100 and the external electronic device 503 perform NAN communication, the electronic device 100 may not perform communication using the cross-connection function. However, if the external electronic device 503 configures the channel of the NDP, used while the electronic device 100 and the external electronic device 503 perform NAN communication, to be identical to the channel established between the external electronic device 503 and the second AP 502, the electronic device 100 and the external electronic device 503 are capable of performing communication using the cross-connection function in the case of using the NDP used while performing NAN communication.

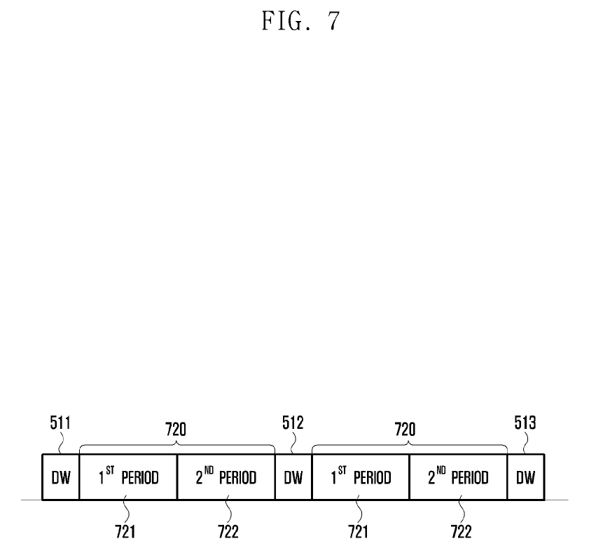

FIG. 7 illustrates schedule information for an electronic device performing NAN communication and communication via cross-connection, according to an embodiment.

The electronic device 100 may conFIGURE(or generate) schedule information related to performing NAN communication and performing communication using the cross-connection function in the process of configuring the NAN communication between the electronic device 100 and the external electronic device 503.

The electronic device 100 may conFIGURE(or generate) schedule information to perform communication using the cross-connection function during a first period 721, which is at least a portion of a period 720 between discovery windows 511, 512, and 513 (e.g., the discovery windows 450 in FIG. 5).

According to an example, in the first period 721 configured to perform communication using the cross-connection function, of the period 720 between the discovery windows 511, 512, and 513, the channel of the NDP used between the electronic device 100 and the external electronic device 503 may be the same as the channel established between the electronic device 100 and the first AP 501.

The electronic device 100 may configure schedule information to perform both NAN communication and communication using the cross-connection function during the first period 721 using the same channel as the channel established between the electronic device 100 and the first AP 501, and the electronic device 100 may simultaneously perform short-range wireless communication between the first AP 501 and the electronic device 100 and NAN communication between the electronic device 100 and the external electronic device 503 during the first period 721, configured to perform communication using the cross-connection function, of the period between the discovery windows 511, 512, and 513.

According to an example, in a second period 722 that is a period configured to perform NAN communication, of the period 720 between the discovery windows 511, 512, and 513, the channel of the NDP used by the electronic device 100 and the external electronic device 503 may be the same as the channel configured in an NAN cluster (e.g., the NAN cluster 200 in FIG. 2) including the electronic device 100 and the external electronic device 503. Alternatively, in the second period 722 configured to perform NAN communication, of the period between the discovery windows 511, 512, and 513, the channel of the NDP established between the electronic device 100 and the external electronic device 503 may be different from the channel established between the electronic device 100 and the first AP 501.

The electronic device 100 may perform NAN communication with the external electronic device 503 during the second period 722, configured to perform NAN communication, of the period 720 between the discovery windows 511, 512, and 513. The electronic device 100 may not perform short-range wireless communication between the first AP 501 and the electronic device 100 during a period, configured to perform NAN communication, of the period between the discovery windows 450.

According to an example, in the second period 722, configured to perform NAN communication, of the period 720 between the discovery windows 511, 512, and 513, the channel of the NDP established between the electronic device 100 and the external electronic device 503 may be configured to be identical to the channel established between the electronic device 100 and the first AP 501. That is, in the period 720 between the discovery windows 511, 512, and 513, the channel of the NDP established between the electronic device 100 and the external electronic device 503 may be configured to be the same as the channel established between the electronic device 100 and the first AP 501. Therefore, the electronic device 100 may simultaneously perform short-range wireless communication between the first AP 501 and the electronic device 100 and NAN communication between the electronic device 100 and the external electronic device 503 in both the first period 721 configured to perform communication using the cross-connection function and the second period 722 configured to perform NAN communication, of the period 720 between the discovery windows 511, 512, and 513.

The electronic device 100 may generate schedule information illustrated in FIG. 7 and transmit a service discovery frame including the schedule information to the external electronic device 503. The schedule information may be included in an NAN availability attribute, and the NAN availability attribute may include a start time of the first period 721, a duration and/or a periodicity of the first period 721, a start time of the second period 722, and a duration and/or a periodicity of the second period 722.

The first period 721 may correspond to one ‘further available window’ (FAW), and the second period 722 may correspond to a FAW different from the FAW corresponding to the first period 721.

In an embodiment, the electronic device 100 may configure the periodicity of the first period 721 and the second period 722 to be substantially the same as the periodicity of the discovery windows 511, 512, and 513. In another embodiment, the electronic device 100 may configure the periodicity of the first period 721 and the second period 722 not to be substantially the same as the periodicity of the discovery windows 511, 512, and 513. In other embodiments, the electronic device 100 may configure the periodicity of the first period 721 and the second period 722 differently.

In an embodiment, the electronic device 100 may configure the duration of the first period 721 and the second period 722 to be the same. In another embodiment, the electronic device 100 may configure the duration of the first period 721 and the second period 722 not to be the same. In other embodiments, the electronic device 100 may configure the duration of the first period 721 and the second period 722 differently.

According to an example, the electronic device 100 may configure the duration of the first period 721 and the second period 722 to be different based on the throughput of communication using the cross-connection function and the throughput of NAN communication. For example, if the throughput of the communication using the cross-connection function is smaller than the throughput of the NAN communication, the electronic device 100 may configure the duration of the first period 721 to be shorter than the duration of the second period 722. For example, if the throughput of the communication using the cross-connection function is greater than the throughput of the NAN communication, the electronic device 100 may configure the duration of the first period 721 to be longer than the duration of the second period 722.

According to an example, the electronic device 100 may configure the duration of the first period 721 and the second period 722 based on the characteristics of a service using the communication using the cross-connection function and the characteristics of a service using the NAN communication. For example, if the service using the NAN communication is a service that requires high throughput, the electronic device 100 may configure the duration of the second period 722 to be longer than the duration of the first period 721.

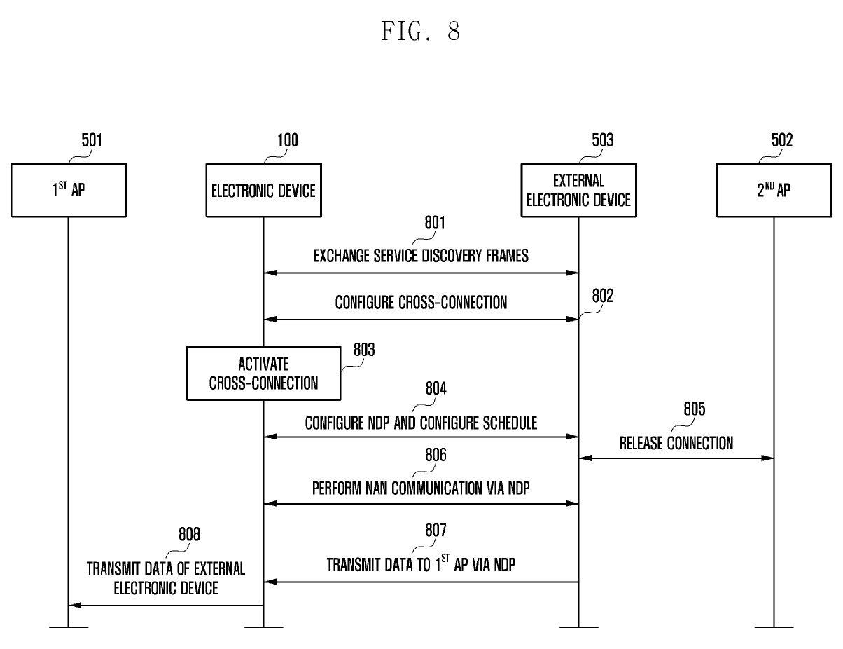

FIG. 8 illustrates an example in which an electronic device activates cross-connection, according to an embodiment.

In operation 801, an electronic device (e.g., the electronic device 100 in FIG. 6) and an external electronic device (e.g., the external electronic device 503 in FIG. 5A) may exchange service discovery frames.

The electronic device 100 may activate NAN communication. According to an example, the electronic device 100 may activate NAN communication when data transmission and/or reception via NAN communication is required, when a service or application related to data transmission and/or reception via NAN communication is activated, and/or when a user input for performing data transmission and/or reception via NAN communication is received

The electronic device 100 may activate NAN communication in a state where short-range wireless communication is activated. Alternatively, the electronic device 100 may activate short-range wireless communication and NAN communication at substantially the same time. The electronic device 100 may be connected to a first AP (e.g., the first AP 501 in FIG. 5A) via short-range wireless communication, and may transmit and/or receive data to and/from the first AP 501.

The electronic device 100 may discover an electronic device (e.g., the external electronic device 503 in FIG. 5A) capable of performing NAN communication, as a part of an operation of activating NAN communication. The electronic device 100 may control the communication circuitry 610 to transmit a service discovery frame to the external electronic device 503.

The service discovery frame may include information related to negotiation for activating NAN communication between the electronic device 100 and the external electronic device 503. According to an example, the service discovery frame may include information of the electronic device 100, performance information of the electronic device 100 (e.g., NAN communication related performance information of the electronic device 100), and/or identification information of a service related to NAN communication.

The service discovery frame may include information of the first AP 501 connected to the electronic device 100 via short-range wireless communication. The information of the first AP 501 may include information on a channel between the first AP 501 and the electronic device 100 (e.g., a channel number, a frequency band of the channel, and/or a bandwidth of the channel), and/or performance information of the first AP 501 (e.g., a function related to short-range wireless communication supported by the first AP 501, a version of Wi-Fi supported by the first AP 501, and/or the number of antennas included in the first AP 501).

The service discovery frame may include information indicating whether the electronic device 100 supports a cross-connection function which is a function capable of providing short-range wireless communication to the external electronic device 503.

The cross-connection function may refer to a function in which the external electronic device 503 is connected to the first AP 501 via the electronic device 100. The external electronic device 503 may be connected to the first AP 501 through an NAN data path (NDP) established (or configured) between the external electronic device 503 and the electronic device 100. Since the cross-connection function may operate based on the NDP, the electronic device 100 and the external electronic device 503 may simultaneously perform NAN communication while performing the cross-connection function. The external electronic device 503 performing the cross-connection function may transmit data to the first AP 501 through the electronic device 100 via the NDP activated during at least a portion of a period between discovery windows (e.g., the discovery windows 450 in FIG. 4) and receive data, transmitted by the first AP 501, from the electronic device 100 via the NDP.

Since the cross-connection function may operate based on the NDP, the electronic device 100 and the external electronic device 503 may perform NAN communication together while exchanging data through the cross-connection function.

According to an example, the service discovery frame may include information on the first AP 501 connected to the electronic device 100 via short-range wireless communication and/or information indicating whether the electronic device 100 supports the cross-connection function.

The electronic device 100 may receive the service discovery frame from the external electronic device 503 in the process of discovering an electronic device (e.g., the external electronic device 503 in FIG. 5A) capable of performing NAN communication.

The service discovery frame may include information about the external electronic device 503, performance information about the external electronic device 503 (e.g., performance information about the external electronic device 503 related to NAN communication), and/or identification information about a service related to NAN communication.

The service discovery frame may include information of the second AP 502 connected to the external electronic device 503 via short-range wireless communication. The information of the second AP 502 may include information on a channel between the second AP 502 and the external electronic device 503 (e.g., a channel number, a frequency band of the channel, and/or a bandwidth of the channel), and/or performance information of the second AP 502 (e.g., a function related to short-range wireless communication supported by the second AP 502, a version of Wi-Fi supported by the second AP 502, and/or the number of antennas included in the second AP 502).

The service discovery frame may include information indicating whether the external electronic device 503 supports a cross-connection function which is a function capable of providing short-range wireless communication to the electronic device 100. The cross-connection function may refer to a function in which the electronic device 100 is connected to the second AP 502 via the external electronic device 503. The external electronic device 503 supporting the cross-connection function may transmit data, received from the second AP 502, to the electronic device 100 and transmit data, transmitted by the electronic device 100, to the second AP 502.

According to an example, the service discovery frame may include information of the second AP 502 connected to the external electronic device 503 via short-range wireless communication and/or information indicating whether the external electronic device 503 supports the cross-connection function.

In operation 802, the electronic device 100 and the external electronic device 503 may configure a cross-connection.

According to an example, the electronic device 100 may identify the service discovery frame transmitted by the external electronic device 503 and identify channel information between the external electronic device 503 and the second AP 502. The electronic device 100 may activate the cross-connection function, based on identifying that the channel between the external electronic device 503 and the second AP 502 is different from the channel between the electronic device 100 and the first AP 501.

According to an example, the electronic device 100 may also activate the cross-connection function, based on identifying the service discovery frame transmitted by the external electronic device 503 and identifying that the external electronic device 503 is connected to the second AP 502.

The electronic device 100 may determine a device to provide the cross-connection function (or a subject performing the cross-connection function), as a part of the operation of activating the cross-connection function. The device to provide the cross-connection function (or the subject performing the cross-connection function) may refer to a device that provides short-range wireless communication to a counterpart electronic device. The device to provide the cross-connection function may maintain a connection (or short-range wireless communication) with an AP and transmit data, transmitted by the counterpart electronic device, to the AP via short-range wireless communication. The device to provide the cross-connection function may be referred to as an owner or a master.

The electronic device 100 may determine the device to provide the cross-connection function, based on the performance of the first AP 501 and/or the performance of the second AP 502.

According to an example, if the first AP 501 supports short-range wireless communication using a higher frequency band, the electronic device 100 may select (or determine) the electronic device 100 connected to the first AP 501 as the device to provide the cross-connection function.

According to an example, if the second AP 502 supports short-range wireless communication using a higher frequency band, the electronic device 100 may select (or determine) the external electronic device 503 connected to the second AP 502 as the device to provide the cross-connection function.

According to an example, if the first AP 501 supports short-range wireless communication using a channel with a larger frequency bandwidth, the electronic device 100 may select (or determine) the electronic device 100 connected to the first AP 501 as the device to provide the cross-connection function.

According to an example, if the second AP 502 supports short-range wireless communication using a channel with a larger frequency bandwidth, the electronic device 100 may select (or determine) the external electronic device 503 connected to the second AP 502 as the device to provide the cross-connection function.

According to an example, if the first AP 501 supports a higher version of short-range wireless communication (e.g., Wi-Fi 7), the electronic device 100 may select (or determine) the electronic device 100 connected to the first AP 501 as the device to provide the cross-connection function.

According to an example, if the second AP 502 supports a higher version of short-range wireless communication (e.g., Wi-Fi 7), the electronic device 100 may select (or determine) the external electronic device 503 connected to the second AP 502 as the device to provide the cross-connection function.

According to an example, if the first AP 501 supports a modulation scheme using a higher modulation coding scheme (MCS), the electronic device 100 may select (or determine) the electronic device 100 connected to the first AP 501 as the device to provide the cross-connection function.

According to an example, if the second AP 502 supports a modulation scheme using a higher MCS, the electronic device 100 may select (or determine) the external electronic device 503 connected to the second AP 502 as the device to provide the cross-connection function.

In determining the device to provide the cross-connection function, the electronic device 100 may compare a value (intent), configured by the electronic device 100, indicating the possibility that the electronic device 100 will provide the cross-connection function and a value, configured by the external electronic device 503, indicating the possibility that the external electronic device 503 will provide the cross-connection function. The value, configured by the external electronic device 503, indicating the possibility that the external electronic device 503 will provide the cross-connection function may be included in the service discovery frame transmitted by the external electronic device 503. The electronic device 100 may determine, as the electronic device to provide the cross-connection function, an electronic device that configures a higher value between the value (intent) indicating the possibility that the electronic device 100 will provide the cross-connection function and the value, configured by the external electronic device 503, indicating the possibility that the external electronic device 503 will provide the cross-connection function.

In the case of determining (or selecting) the electronic device 100 as the electronic device to provide the cross-connection function, the electronic device 100 may control the communication circuitry 610 to transmit the service discovery frame including information indicating the electronic device (e.g., the electronic device 100) to provide the cross-connection function to the external electronic device 503. Upon receiving the service discovery frame including information indicating the electronic device (e.g., the electronic device 100) to provide the cross-connection function, the external electronic device 503 may release the connection via short-range wireless communication between the external electronic device 503 and the second AP 502.

In operation 803, the electronic device 100 may activate a cross-connection.

In operation 804, the electronic device 100 may configure an NDP and configure a schedule, based on the service discovery frame.

In the process of configuring NAN communication between the electronic device 100 and the external electronic device 503, the electronic device 100 may conFIGURE(or generate) schedule information related to performing NAN communication and performing communication using the cross-connection function.

The electronic device 100 may conFIGURE(or generate) schedule information to perform communication using the cross-connection function during at least a portion of the period between the discovery windows 450. The electronic device 100 may conFIGURE(or generate) schedule information to perform NAN communication during another portion of the period between the discovery windows 450.

According to an example, in a section, configured to perform communication using the cross-connection function, of the period between the discovery windows 450, a channel of an NDP established between the electronic device 100 and the external electronic device 503 may be the same as a channel established between the electronic device 100 and the first AP 501. The electronic device 100 may configure schedule information to perform NAN communication using the same channel as the channel established between the electronic device 100 and the first AP 501, and the electronic device 100 may simultaneously perform short-range wireless communication between the first AP 501 and the electronic device 100 and NAN communication between the electronic device 100 and the external electronic device 503 in the section, configured to perform communication using the cross-connection function, of the period between the discovery windows 450.

According to an example, in a section, configured to perform NAN communication, of the period between the discovery windows 450, a channel of an NDP established between the electronic device 100 and the external electronic device 503 may be the same as a channel configured in an NAN cluster (e.g., the NAN cluster 200 in FIG. 2) including the electronic device 100 and the external electronic device 503. Alternatively, in a section, configured to perform NAN communication, of the period between the discovery windows 450, a channel of an NDP established between the electronic device 100 and the external electronic device 503 may be different from a channel established between the electronic device 100 and the first AP 501. The electronic device 100 may perform NAN communication with the external electronic device 503 in the section, configured to perform NAN communication, of the period between the discovery windows 450. The electronic device 100 may not perform short-range wireless communication between the first AP 501 and the electronic device 100 in the section, configured to perform NAN communication, of the period between the discovery windows 450.

Based on the above-described scheme, through the cross-connection function, the electronic device 100 and the external electronic device 503 may perform NAN communication during the period between the discovery windows 450 and also perform both NAN communication and communication using the cross-connection function during at least a portion of the period between the discovery windows 450.

According to an example, in the section, configured to perform NAN communication, of the period between the discovery windows 450, the channel of the NDP established between the electronic device 100 and the external electronic device 503 may be configured to be identical to the channel established between the electronic device 100 and the first AP 501. That is, in the section between the discovery windows 450, the channel established between the electronic device 100 and the external electronic device 503 may be configured to be identical to the channel established between the electronic device 100 and the first AP 501. Therefore, the electronic device 100 may simultaneously perform short-range wireless communication between the first AP 501 and the electronic device 100 and NAN communication between the electronic device 100 and the external electronic device 503 during, of the period between the discovery windows 450, both the section configured to perform communication using the cross-connection function and the section configured to perform NAN communication.

In operation 805, the external electronic device 100 may release a connection with the second AP 502 via short-range wireless communication.

The external electronic device 100 may receive data provided by the first AP 501 through the NDP, using the cross-connection function, and thus release the connection with the second AP 502 via short-range wireless communication.

In operation 806, the electronic device 100 and the external electronic device 503 may perform NAN communication via the NDP.

The electronic device 100 and the external electronic device 503 may perform NAN communication via the NDP during the period 720 between discovery windows (e.g., the discovery windows 511, 512, and 513 in FIG. 7), based on the schedule information.

In operation 807, the external electronic device 503 may transmit, to the electronic device 100 via NDP, data to be transmitted to the first AP 501.

The external electronic device 503 may transmit data, to be transmitted to the first AP 501, to the electronic device 100 via NDP during the first period 721 between the discovery windows 511, 512, and 513.

In operation 808, the electronic device 100 may transmit data, transmitted by the external electronic device 503, to the first AP 501 via short-range wireless communication.

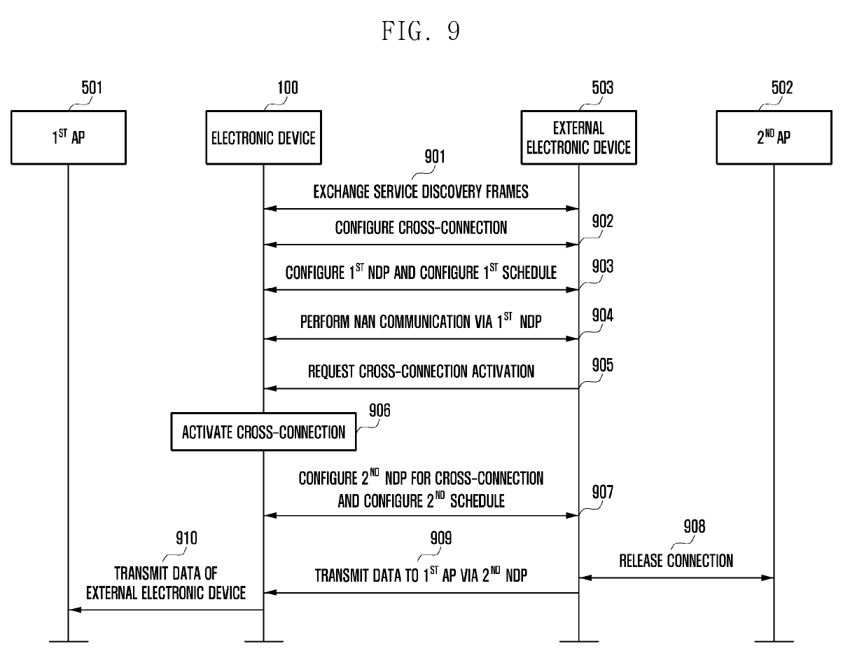

FIG. 9 illustrates an example in which an electronic device activates cross-connection, according to an embodiment.

In operation 901, an electronic device (e.g., the electronic device 100 in FIG. 6) and an external electronic device (e.g., the external electronic device 503 in FIG. 5A) may exchange service discovery frames.

The electronic device 100 may activate NAN communication. According to an example, the electronic device 100 may activate NAN communication when data transmission and/or reception via NAN communication is required, when a service or application related to data transmission and/or reception via NAN communication is activated, and/or when a user input for performing data transmission and/or reception via NAN communication is received

The electronic device 100 may activate NAN communication in a state where short-range wireless communication is activated. Alternatively, the electronic device 100 may activate short-range wireless communication and NAN communication at substantially the same time. The electronic device 100 may be connected to a first AP (e.g., the first AP 501 in FIG. 5A) via short-range wireless communication, and may transmit and/or receive data to and/from the first AP 501.

The electronic device 100 may discover an electronic device (e.g., the external electronic device 503 in FIG. 5A) capable of performing NAN communication, as a part of an operation of activating NAN communication. The electronic device 100 may control the communication circuitry 610 to transmit a service discovery frame to the external electronic device 503.

The service discovery frame may include information related to negotiation for activating NAN communication between the electronic device 100 and the external electronic device 503. According to an example, the service discovery frame may include information of the electronic device 100, performance information of the electronic device 100 (e.g., NAN communication related performance information of the electronic device 100), and/or identification information of a service related to NAN communication.

The service discovery frame may include information of the first AP 501 connected to the electronic device 100 via short-range wireless communication. The information of the first AP 501 may include information on a channel between the first AP 501 and the electronic device 100 (e.g., a channel number, a frequency band of the channel, and/or a bandwidth of the channel), and/or performance information of the first AP 501 (e.g., a function related to short-range wireless communication supported by the first AP 501, a version of Wi-Fi supported by the first AP 501, and/or the number of antennas included in the first AP 501).

The service discovery frame may include information indicating whether the electronic device 100 supports a cross-connection function which is a function capable of providing short-range wireless communication to the external electronic device 503.

The cross-connection function may refer to a function in which the external electronic device 503 is connected to the first AP 501 via the electronic device 100. The external electronic device 503 may be connected to the first AP 501 through an NAN data path (NDP) established (or configured) between the external electronic device 503 and the electronic device 100. Since the cross-connection function may operate based on the NDP, the electronic device 100 and the external electronic device 503 may simultaneously perform NAN communication while performing the cross-connection function. The external electronic device 503 performing the cross-connection function may transmit data to the first AP 501 through the electronic device 100 via the NDP activated during at least a portion of a period between discovery windows (e.g., the discovery windows 450 in FIG. 4) and receive data, transmitted by the first AP 501, from the electronic device 100 via the NDP.

Since the cross-connection function may operate based on the NDP, the electronic device 100 and the external electronic device 503 may perform NAN communication together while exchanging data through the cross-connection function.

According to an example, the service discovery frame may include information on the first AP 501 connected to the electronic device 100 via short-range wireless communication and/or information indicating whether the electronic device 100 supports the cross-connection function.

The electronic device 100 may receive the service discovery frame from the external electronic device 503 in the process of discovering an electronic device (e.g., the external electronic device 503 in FIG. 5A) capable of performing NAN communication.

The service discovery frame may include information about the external electronic device 503, performance information about the external electronic device 503 (e.g., performance information about the external electronic device 503 related to NAN communication), and/or identification information about a service related to NAN communication.

The service discovery frame may include information of the second AP 502 connected to the external electronic device 503 via short-range wireless communication. The information of the second AP 502 may include information on a channel between the second AP 502 and the external electronic device 503 (e.g., a channel number, a frequency band of the channel, and/or a bandwidth of the channel), and/or performance information of the second AP 502 (e.g., a function related to short-range wireless communication supported by the second AP 502, a version of Wi-Fi supported by the second AP 502, and/or the number of antennas included in the second AP 502).

The service discovery frame may include information indicating whether the external electronic device 503 supports a cross-connection function which is a function capable of providing short-range wireless communication to the electronic device 100. The cross-connection function may refer to a function in which the electronic device 100 is connected to the second AP 502 via the external electronic device 503. The external electronic device 503 supporting the cross-connection function may transmit data, received from the second AP 502, to the electronic device 100 and transmit data, transmitted by the electronic device 100, to the second AP 502.

According to an example, the service discovery frame may include information of the second AP 502 connected to the external electronic device 503 via short-range wireless communication and/or information indicating whether the external electronic device 503 supports the cross-connection function.

In operation 902, the electronic device 100 and the external electronic device 503 may configure a cross-connection, based on the service discovery frame.

According to an example, the electronic device 100 may identify the service discovery frame transmitted by the external electronic device 503 and identify channel information between the external electronic device 503 and the second AP 502. The electronic device 100 may activate the cross-connection function, based on identifying that the channel between the external electronic device 503 and the second AP 502 is different from the channel between the electronic device 100 and the first AP 501.

According to an example, the electronic device 100 may also activate the cross-connection function, based on identifying the service discovery frame transmitted by the external electronic device 503 and identifying that the external electronic device 503 is connected to the second AP 502.

The electronic device 100 may determine a device to provide the cross-connection function (or a subject performing the cross-connection function), as a part of the operation of activating the cross-connection function. The device to provide the cross-connection function (or the subject performing the cross-connection function) may refer to a device that provides short-range wireless communication to a counterpart electronic device. The device to provide the cross-connection function may maintain a connection (or short-range wireless communication) with an AP and transmit data, transmitted by the counterpart electronic device, to the AP via short-range wireless communication. The device to provide the cross-connection function may be referred to as an owner or a master.

The electronic device 100 may determine the device to provide the cross-connection function, based on the performance of the first AP 501 and/or the performance of the second AP 502.

According to an example, if the first AP 501 supports short-range wireless communication using a higher frequency band, the electronic device 100 may select (or determine) the electronic device 100 connected to the first AP 501 as the device to provide the cross-connection function.

According to an example, if the second AP 502 supports short-range wireless communication using a higher frequency band, the electronic device 100 may select (or determine) the external electronic device 503 connected to the second AP 502 as the device to provide the cross-connection function.

According to an example, if the first AP 501 supports short-range wireless communication using a channel with a larger frequency bandwidth, the electronic device 100 may select (or determine) the electronic device 100 connected to the first AP 501 as the device to provide the cross-connection function.

According to an example, if the second AP 502 supports short-range wireless communication using a channel with a larger frequency bandwidth, the electronic device 100 may select (or determine) the external electronic device 503 connected to the second AP 502 as the device to provide the cross-connection function.

According to an example, if the first AP 501 supports a higher version of short-range wireless communication (e.g., Wi-Fi 7), the electronic device 100 may select (or determine) the electronic device 100 connected to the first AP 501 as the device to provide the cross-connection function.

According to an example, if the second AP 502 supports a higher version of short-range wireless communication (e.g., Wi-Fi 7), the electronic device 100 may select (or determine) the external electronic device 503 connected to the second AP 502 as the device to provide the cross-connection function.

According to an example, if the first AP 501 supports a modulation scheme using a higher modulation coding scheme (MCS), the electronic device 100 may select (or determine) the electronic device 100 connected to the first AP 501 as the device to provide the cross-connection function.

According to an example, if the second AP 502 supports a modulation scheme using a higher MCS, the electronic device 100 may select (or determine) the external electronic device 503 connected to the second AP 502 as the device to provide the cross-connection function.

In determining the device to provide the cross-connection function, the electronic device 100 may compare a value (intent), configured by the electronic device 100, indicating the possibility that the electronic device 100 will provide the cross-connection function and a value, configured by the external electronic device 503, indicating the possibility that the external electronic device 503 will provide the cross-connection function. The value, configured by the external electronic device 503, indicating the possibility that the external electronic device 503 will provide the cross-connection function may be included in the service discovery frame transmitted by the external electronic device 503. The electronic device 100 may determine, as the electronic device to provide the cross-connection function, an electronic device that configures a higher value between the value (intent) indicating the possibility that the electronic device 100 will provide the cross-connection function and the value, configured by the external electronic device 503, indicating the possibility that the external electronic device 503 will provide the cross-connection function.

In the case of determining (or selecting) the electronic device 100 as the electronic device to provide the cross-connection function, the electronic device 100 may control the communication circuitry 610 to transmit the service discovery frame including information indicating the electronic device (e.g., the electronic device 100) to provide the cross-connection function to the external electronic device 503.

After configuring the cross-connection, the electronic device 100 may not activate the cross-connection until the external electronic device 503 transmits a cross-connection activation request.

In operation 903, the electronic device 100 and the external electronic device 503 may configure a first NDP and configure first schedule information for the first NDP.

The first NDP may refer to an NDP used by the electronic device 100 and the external electronic device 503 during a second period (e.g., the second period 722 in FIG. 7), which is a period configured to perform NAN communication between discovery windows (e.g., the discovery windows 511, 512, and 513 in FIG. 7).

The electronic device 100 and the external electronic device 503 may perform NAN communication, based on first schedule information corresponding to the first NDP.

According to an example, the first schedule information may be schedule information related to the first period 721 configured to perform communication using cross-connection between the discovery windows 511, 512, and 513 and the second period 722 configured to perform NAN communication between the discovery windows 511, 512, and 513. The first NDP is an NDP used to perform NAN communication, but the electronic device 100 and the external electronic device 503 may conFIGURE(or generate) the first schedule information to include both information related to the first period 721 and information related to the second period 722, considering that communication using the cross-connection function is performed.

According to another example, the first schedule information may be schedule information related to the second period 722 configured to perform NAN communication between the discovery windows 511, 512, and 513. The first schedule information may not include information about the first period 721 configured to perform communication using the cross-connection between the discovery windows 511, 512, and 513. When performing NAN communication based on the first schedule information, the electronic device 100 and the external electronic device 503 may perform NAN communication during the second period and may not perform separate communication (including communication using the cross-connection function) during the first period before the cross-connection function is activated.

In operation 904, the electronic device 100 and the external electronic device 503 may perform NAN communication via the first NDP.

In operation 905, the external electronic device 503 may request a cross-connection activation from the electronic device 100.

Requesting the cross-connection activation may be implemented by transmitting a service discovery frame including information requesting the cross-connection activation.

In operation 906, the electronic device 100 may activate the cross-connection.

In operation 907, the electronic device 100 and the external electronic device 503 may configure a second NDP for the cross-connection and configure second schedule information corresponding to the second NDP.

The second NDP may refer to an NDP used by the electronic device 100 and the external electronic device 503 during a first period (e.g., the first period 721 in FIG. 7), which is a period configured to perform NAN communication between the discovery windows 511, 512, and 513.

The electronic device 100 and the external electronic device 503 may perform communication using the cross-connection function, based on the second schedule information corresponding to the second NDP.

According to an example, the second schedule information may be schedule information related to the first period 721 configured to perform communication using cross-connection between the discovery windows 511, 512, and 513 and the second period 722 configured to perform NAN communication between the discovery windows 511, 512, and 513. The schedule information of the first NDP may cause the electronic device 100 and the external electronic device 503 to perform NAN communication via the first NDP during a period between the discovery windows 450 or at least a portion of the period between the discovery windows 450. The schedule information of the second NDP may cause the electronic device 100 and the external electronic device 503 to perform NAN communication and communication using the cross-connection function together via the second NDP during a portion, other than the period during which the electronic device 100 and the external electronic device 503 perform NAN communication via the first NDP of the period between the discovery windows 450.

In operation 908, the external electronic device 100 may release a connection with the second AP 502.

The external electronic device 100 may receive data provided by the first AP 501 through the NDP, using the cross-connection function, and thus release the connection with the second AP 502 via short-range wireless communication.

In operation 909, the external electronic device 503 may transmit, to the electronic device 100 via the second NDP, data to be transmitted to the first AP 501.

The electronic device 100 and the external electronic device 503 may perform communication using the cross-connection function via the second NDP during the period 720 between discovery windows (e.g., the discovery windows 511, 512, and 513 in FIG. 7), based on the second schedule information.

In operation 910, the electronic device 100 may transmit data, received from the external electronic device 503, to the first AP 501.

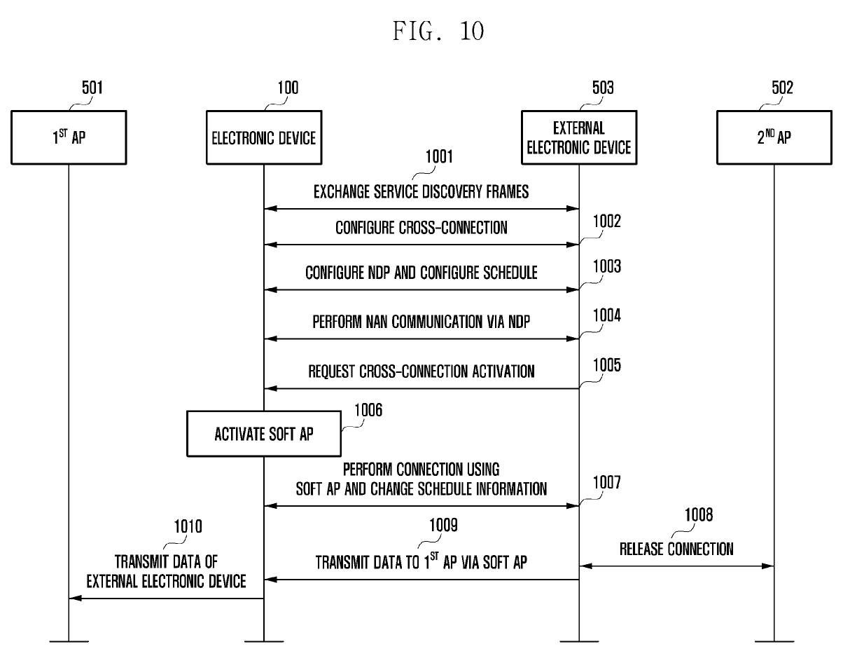

FIG. 10 illustrates an example in which an electronic device activates cross-connection, according to an embodiment.

In operation 1001, an electronic device (e.g., the electronic device 100 in FIG. 6) and an external electronic device (e.g., the external electronic device 503 in FIG. 5A) may exchange service discovery frames.

The electronic device 100 may activate NAN communication. According to an example, the electronic device 100 may activate NAN communication when data transmission and/or reception via NAN communication is required, when a service or application related to data transmission and/or reception via NAN communication is activated, and/or when a user input for performing data transmission and/or reception via NAN communication is received

The electronic device 100 may activate NAN communication in a state where short-range wireless communication is activated. Alternatively, the electronic device 100 may activate short-range wireless communication and NAN communication at substantially the same time. The electronic device 100 may be connected to a first AP (e.g., the first AP 501 in FIG. 5A) via short-range wireless communication, and may transmit and/or receive data to and/from the first AP 501.

The electronic device 100 may discover an electronic device (e.g., the external electronic device 503 in FIG. 5A) capable of performing NAN communication, as a part of an operation of activating NAN communication. The electronic device 100 may control the communication circuitry 610 to transmit a service discovery frame to the external electronic device 503.

The service discovery frame may include information related to negotiation for activating NAN communication between the electronic device 100 and the external electronic device 503. According to an example, the service discovery frame may include information of the electronic device 100, performance information of the electronic device 100 (e.g., NAN communication related performance information of the electronic device 100), and/or identification information of a service related to NAN communication.

The service discovery frame may include information of the first AP 501 connected to the electronic device 100 via short-range wireless communication. The information of the first AP 501 may include information on a channel between the first AP 501 and the electronic device 100 (e.g., a channel number, a frequency band of the channel, and/or a bandwidth of the channel), and/or performance information of the first AP 501 (e.g., a function related to short-range wireless communication supported by the first AP 501, a version of Wi-Fi supported by the first AP 501, and/or the number of antennas included in the first AP 501).

The service discovery frame may include information indicating whether the electronic device 100 supports a soft AP-based cross-connection function which is a function capable of providing short-range wireless communication to the external electronic device 503. The soft AP may refer to a function in which the electronic device 100 performs the role of an AP for the external electronic device 503. The electronic device 100 may provide short-range wireless communication to the external electronic device 503 through a channel established based on the soft AP.

The soft AP-based cross-connection function may refer to a function in which the external electronic device 503 is connected to the first AP 501 via the electronic device 100. The external electronic device 503 may be connected to the first AP 501 through a soft AP-based channel established (or configured) between the external electronic device 503 and the electronic device 100.

According to an example, the service discovery frame may include information on the first AP 501 connected to the electronic device 100 via short-range wireless communication and/or information indicating whether the electronic device 100 supports the cross-connection function.

The electronic device 100 may receive the service discovery frame from the external electronic device 503 in the process of discovering an electronic device (e.g., the external electronic device 503 in FIG. 5A) capable of performing NAN communication.

The service discovery frame may include information about the external electronic device 503, performance information about the external electronic device 503 (e.g., performance information about the external electronic device 503 related to NAN communication), and/or identification information about a service related to NAN communication.

The service discovery frame may include information of the second AP 502 connected to the external electronic device 503 via short-range wireless communication. The information of the second AP 502 may include information on a channel between the second AP 502 and the external electronic device 503 (e.g., a channel number, a frequency band of the channel, and/or a bandwidth of the channel), and/or performance information of the second AP 502 (e.g., a function related to short-range wireless communication supported by the second AP 502, a version of Wi-Fi supported by the second AP 502, and/or the number of antennas included in the second AP 502).

The service discovery frame may include information indicating whether the external electronic device 503 supports the soft AP-based cross-connection function which is a function capable of providing short-range wireless communication to the electronic device 100. The external electronic device 503 supporting the soft AP-based cross-connection function may transmit data, received from the second AP 502, to the electronic device 100 and transmit data, transmitted by the electronic device 100, to the second AP 502.

The service discovery frame may include information indicating whether the external electronic device 503 supports the soft AP-based cross-connection function which is a function capable of providing short-range wireless communication to the electronic device 100.

According to an example, the service discovery frame may include information of the second AP 502 connected to the external electronic device 503 via short-range wireless communication and/or information indicating whether the external electronic device 503 supports the soft AP-based cross-connection function.

In operation 1002, the electronic device 100 and the external electronic device 503 may configure a cross-connection, based on the service discovery frame.

According to an example, the electronic device 100 may identify the service discovery frame transmitted by the external electronic device 503 and identify channel information between the external electronic device 503 and the second AP 502. The electronic device 100 may activate the cross-connection function, based on identifying that the channel between the external electronic device 503 and the second AP 502 is different from the channel between the electronic device 100 and the first AP 501.

According to an example, the electronic device 100 may also activate the cross-connection function, based on identifying the service discovery frame transmitted by the external electronic device 503 and identifying that the external electronic device 503 is connected to the second AP 502.

The electronic device 100 may determine a device to provide the cross-connection function (or a subject performing the cross-connection function), as a part of the operation of activating the cross-connection function. The device to provide the cross-connection function (or the subject performing the cross-connection function) may refer to a device that provides short-range wireless communication to a counterpart electronic device. The device to provide the cross-connection function may maintain a connection (or short-range wireless communication) with an AP and transmit data, transmitted by the counterpart electronic device, to the AP via short-range wireless communication. The device to provide the cross-connection function may be referred to as an owner or a master.

The electronic device 100 may determine the device to provide the cross-connection function, based on the performance of the first AP 501 and/or the performance of the second AP 502.

According to an example, if the first AP 501 supports short-range wireless communication using a higher frequency band, the electronic device 100 may select (or determine) the electronic device 100 connected to the first AP 501 as the device to provide the cross-connection function.

According to an example, if the second AP 502 supports short-range wireless communication using a higher frequency band, the electronic device 100 may select (or determine) the external electronic device 503 connected to the second AP 502 as the device to provide the cross-connection function.

According to an example, if the first AP 501 supports short-range wireless communication using a channel with a larger frequency bandwidth, the electronic device 100 may select (or determine) the electronic device 100 connected to the first AP 501 as the device to provide the cross-connection function.

According to an example, if the second AP 502 supports short-range wireless communication using a channel with a larger frequency bandwidth, the electronic device 100 may select (or determine) the external electronic device 503 connected to the second AP 502 as the device to provide the cross-connection function.

According to an example, if the first AP 501 supports a higher version of short-range wireless communication (e.g., Wi-Fi 7), the electronic device 100 may select (or determine) the electronic device 100 connected to the first AP 501 as the device to provide the cross-connection function.

According to an example, if the second AP 502 supports a higher version of short-range wireless communication (e.g., Wi-Fi 7), the electronic device 100 may select (or determine) the external electronic device 503 connected to the second AP 502 as the device to provide the cross-connection function.

According to an example, if the first AP 501 supports a modulation scheme using a higher modulation coding scheme (MCS), the electronic device 100 may select (or determine) the electronic device 100 connected to the first AP 501 as the device to provide the cross-connection function.

According to an example, if the second AP 502 supports a modulation scheme using a higher MCS, the electronic device 100 may select (or determine) the external electronic device 503 connected to the second AP 502 as the device to provide the cross-connection function.

In determining the device to provide the cross-connection function, the electronic device 100 may compare a value (intent), configured by the electronic device 100, indicating the possibility that the electronic device 100 will provide the cross-connection function and a value, configured by the external electronic device 503, indicating the possibility that the external electronic device 503 will provide the cross-connection function. The value, configured by the external electronic device 503, indicating the possibility that the external electronic device 503 will provide the cross-connection function may be included in the service discovery frame transmitted by the external electronic device 503. The electronic device 100 may determine, as the electronic device to provide the cross-connection function, an electronic device that configures a higher value between the value (intent) indicating the possibility that the electronic device 100 will provide the cross-connection function and the value, configured by the external electronic device 503, indicating the possibility that the external electronic device 503 will provide the cross-connection function.

In the case of determining (or selecting) the electronic device 100 as the electronic device to provide the cross-connection function, the electronic device 100 may control the communication circuitry 610 to transmit the service discovery frame including information indicating the electronic device (e.g., the electronic device 100) to provide the cross-connection function to the external electronic device 503.

After configuring the cross-connection, the electronic device 100 may not activate the cross-connection until the external electronic device 503 transmits a cross-connection activation request.

In operation 1003, the electronic device 100 and the external electronic device 503 may configure an NDP and configure schedule information for the NDP.

The NDP may refer to an NDP used by the electronic device 100 and the external electronic device 503 during a period, configured to perform NAN communication, of the period 720 between discovery windows (e.g., the discovery windows 511, 512, and 513 in FIG. 7).

According to an example, the schedule information may be schedule information related to the period configured to perform NAN communication during the period 720 between the discovery windows 511, 512, and 513.

In operation 1004, the electronic device 100 and the external electronic device 503 may perform NAN communication via the NDP.

In operation 1005, the external electronic device 503 may request a soft AP-based cross-connection activation from the electronic device 100.

Requesting the soft AP-based cross-connection activation may be implemented by transmitting a service discovery frame including information requesting the soft AP-based cross-connection activation.

In operation 1006, the electronic device 100 may activate the soft AP-based cross-connection.

In operation 1007, the electronic device 100 and the external electronic device 503 may perform a connection to each other using the soft AP and change the schedule information.

The electronic device 100 and the external electronic device 503 may be connected to each other through a channel generated based on the soft AP. The channel generated based on the soft AP may be configured as a channel identical to the channel between the electronic device 100 and the first AP 501.

In configuring the schedule information, the electronic device 100 may configure a channel corresponding to the NDP to be the same as a channel connected between the electronic device 100 and the first AP 501 via short-range wireless communication. The electronic device 100 may perform NAN communication with the external electronic device 503 through the NDP corresponding to the same channel as the channel connected between the electronic device 100 and the first AP 501 via short-range wireless communication.

Since the NDP is configured to have the same channel as the channel connected via short-range wireless communication between the electronic device 100 and the first AP 501, the electronic device 100 may perform NAN communication through the NDP in any period between the discovery windows 511, 512, and 513, transmit data received from the external electronic device 503 to the first AP 501 through a channel generated based on the soft AP, and transmit data received from the first AP 501 to the external electronic device 503 through the channel generated based on the soft AP.

In operation 1008, the external electronic device 100 may release a connection with the second AP 502.

The external electronic device 100 may receive data, provided by the first AP 501, from the electronic device 100 through the channel generated based on the soft AP, using the cross-connection function, and thus release the connection with the second AP 502 via short-range wireless communication.

In operation 1009, the external electronic device 503 may transmit, to the electronic device 100 via the channel generated based on the soft AP, data to be transmitted to the first AP 501.

In operation 1010, the electronic device 100 may transmit data, received from the external electronic device 503, to the first AP 501.

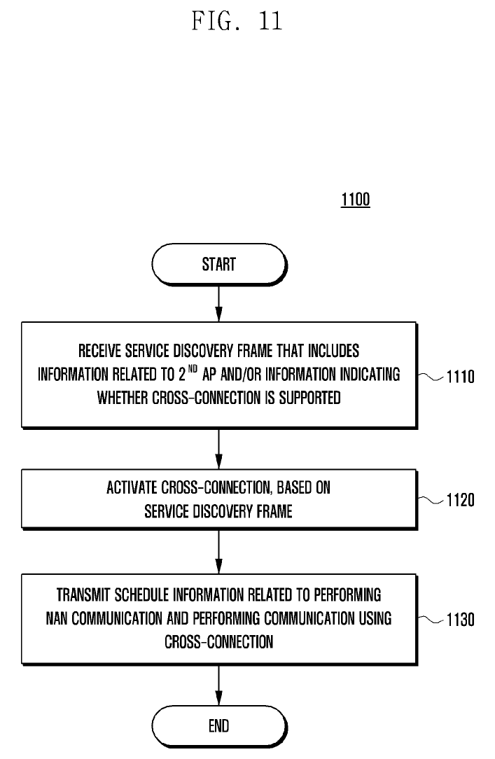

FIG. 11 is a flowchart 1100 illustrating an operating method of an electronic device according to an embodiment.

In operation 1110, an electronic device (e.g., the electronic device 100 in FIG. 6) may receive, from an external electronic device (e.g., the external electronic device 503 in FIG. 5A), a service discovery frame that includes information related to a second AP (e.g., the second AP 502 in FIG. 5A) and/or information indicating whether a cross-connection is supported.

The electronic device 100 may activate NAN communication. According to an example, the electronic device 100 may activate NAN communication when data transmission and/or reception via NAN communication is required, when a service or application related to data transmission and/or reception via NAN communication is activated, and/or when a user input for performing data transmission and/or reception via NAN communication is received

The electronic device 100 may activate NAN communication in a state where short-range wireless communication is activated. Alternatively, the electronic device 100 may activate short-range wireless communication and NAN communication at substantially the same time. The electronic device 100 may be connected to a first AP (e.g., the first AP 501 in FIG. 5A) via short-range wireless communication, and may transmit and/or receive data to and/from the first AP 501.

The electronic device 100 may discover an electronic device (e.g., the external electronic device 503 in FIG. 5A) capable of performing NAN communication, as a part of an operation of activating NAN communication. The electronic device 100 may control the communication circuitry 610 to transmit a service discovery frame to the external electronic device 503.

The service discovery frame may include information related to negotiation for activating NAN communication between the electronic device 100 and the external electronic device 503. According to an example, the service discovery frame may include information of the electronic device 100, performance information of the electronic device 100 (e.g., NAN communication related performance information of the electronic device 100), and/or identification information of a service related to NAN communication.

The service discovery frame may include information of the first AP 501 connected to the electronic device 100 via short-range wireless communication. The information of the first AP 501 may include information on a channel between the first AP 501 and the electronic device 100 (e.g., a channel number, a frequency band of the channel, and/or a bandwidth of the channel), and/or performance information of the first AP 501 (e.g., a function related to short-range wireless communication supported by the first AP 501, a version of Wi-Fi supported by the first AP 501, and/or the number of antennas included in the first AP 501).

The service discovery frame may include information indicating whether the electronic device 100 supports a cross-connection function which is a function capable of providing short-range wireless communication to the external electronic device 503.

The cross-connection function may refer to a function in which the external electronic device 503 is connected to the first AP 501 via the electronic device 100. The external electronic device 503 may be connected to the first AP 501 through an NAN data path (NDP) established (or configured) between the external electronic device 503 and the electronic device 100. Since the cross-connection function may operate based on the NDP, the electronic device 100 and the external electronic device 503 may simultaneously perform NAN communication while performing the cross-connection function. The external electronic device 503 performing the cross-connection function may transmit data to the first AP 501 through the electronic device 100 via the NDP activated during at least a portion of a period between discovery windows (e.g., the discovery windows 450 in FIG. 4) and receive data, transmitted by the first AP 501, from the electronic device 100 via the NDP.

Since the cross-connection function may operate based on the NDP, the electronic device 100 and the external electronic device 503 may perform NAN communication together while exchanging data through the cross-connection function.

According to an example, the service discovery frame may include information on the first AP 501 connected to the electronic device 100 via short-range wireless communication and/or information indicating whether the electronic device 100 supports the cross-connection function.

The electronic device 100 may receive the service discovery frame from the external electronic device 503 in the process of discovering an electronic device (e.g., the external electronic device 503 in FIG. 5A) capable of performing NAN communication.

The service discovery frame may include information about the external electronic device 503, performance information about the external electronic device 503 (e.g., performance information about the external electronic device 503 related to NAN communication), and/or identification information about a service related to NAN communication.

The service discovery frame may include information of the second AP 502 connected to the external electronic device 503 via short-range wireless communication. The information of the second AP 502 may include information on a channel between the second AP 502 and the external electronic device 503 (e.g., a channel number, a frequency band of the channel, and/or a bandwidth of the channel), and/or performance information of the second AP 502 (e.g., a function related to short-range wireless communication supported by the second AP 502, a version of Wi-Fi supported by the second AP 502, and/or the number of antennas included in the second AP 502).

The service discovery frame may include information indicating whether the external electronic device 503 supports a cross-connection function which is a function capable of providing short-range wireless communication to the electronic device 100. The cross-connection function may refer to a function in which the electronic device 100 is connected to the second AP 502 via the external electronic device 503. The external electronic device 503 supporting the cross-connection function may transmit data, received from the second AP 502, to the electronic device 100 and transmit data, transmitted by the electronic device 100, to the second AP 502.

According to an example, the service discovery frame may include information of the second AP 502 connected to the external electronic device 503 via short-range wireless communication and/or information indicating whether the external electronic device 503 supports the cross-connection function.

In operation 1120, the electronic device 100 may activate a cross-connection, based on the service discovery frame.

According to an example, the electronic device 100 may identify the service discovery frame transmitted by the external electronic device 503 and identify channel information between the external electronic device 503 and the second AP 502. The electronic device 100 may activate the cross-connection function, based on identifying that the channel between the external electronic device 503 and the second AP 502 is different from the channel between the electronic device 100 and the first AP 501.

According to an example, the electronic device 100 may also activate the cross-connection function, based on identifying the service discovery frame transmitted by the external electronic device 503 and identifying that the external electronic device 503 is connected to the second AP 502.

The electronic device 100 may determine a device to provide the cross-connection function (or a subject performing the cross-connection function), as a part of the operation of activating the cross-connection function. The device to provide the cross-connection function (or the subject performing the cross-connection function) may refer to a device that provides short-range wireless communication to a counterpart electronic device. The device to provide the cross-connection function may maintain a connection (or short-range wireless communication) with an AP and transmit data, transmitted by the counterpart electronic device, to the AP via short-range wireless communication. The device to provide the cross-connection function may be referred to as an owner or a master.

The electronic device 100 may determine the device to provide the cross-connection function, based on the performance of the first AP 501 and/or the performance of the second AP 502.

According to an example, if the first AP 501 supports short-range wireless communication using a higher frequency band, the electronic device 100 may select (or determine) the electronic device 100 connected to the first AP 501 as the device to provide the cross-connection function.

According to an example, if the second AP 502 supports short-range wireless communication using a higher frequency band, the electronic device 100 may select (or determine) the external electronic device 503 connected to the second AP 502 as the device to provide the cross-connection function.

According to an example, if the first AP 501 supports short-range wireless communication using a channel with a larger frequency bandwidth, the electronic device 100 may select (or determine) the electronic device 100 connected to the first AP 501 as the device to provide the cross-connection function.

According to an example, if the second AP 502 supports short-range wireless communication using a channel with a larger frequency bandwidth, the electronic device 100 may select (or determine) the external electronic device 503 connected to the second AP 502 as the device to provide the cross-connection function.

According to an example, if the first AP 501 supports a higher version of short-range wireless communication (e.g., Wi-Fi 7), the electronic device 100 may select (or determine) the electronic device 100 connected to the first AP 501 as the device to provide the cross-connection function.

According to an example, if the second AP 502 supports a higher version of short-range wireless communication (e.g., Wi-Fi 7), the electronic device 100 may select (or determine) the external electronic device 503 connected to the second AP 502 as the device to provide the cross-connection function.

According to an example, if the first AP 501 supports a modulation scheme using a higher modulation coding scheme (MCS), the electronic device 100 may select (or determine) the electronic device 100 connected to the first AP 501 as the device to provide the cross-connection function.

According to an example, if the second AP 502 supports a modulation scheme using a higher MCS, the electronic device 100 may select (or determine) the external electronic device 503 connected to the second AP 502 as the device to provide the cross-connection function.

In determining the device to provide the cross-connection function, the electronic device 100 may compare a value (intent), configured by the electronic device 100, indicating the possibility that the electronic device 100 will provide the cross-connection function and a value, configured by the external electronic device 503, indicating the possibility that the external electronic device 503 will provide the cross-connection function. The value, configured by the external electronic device 503, indicating the possibility that the external electronic device 503 will provide the cross-connection function may be included in the service discovery frame transmitted by the external electronic device 503. The electronic device 100 may determine, as the electronic device to provide the cross-connection function, an electronic device that configures a higher value between the value (intent) indicating the possibility that the electronic device 100 will provide the cross-connection function and the value, configured by the external electronic device 503, indicating the possibility that the external electronic device 503 will provide the cross-connection function.

The above-described examples are described as examples for selecting an electronic device to provide the cross-connection function, and in addition to the above-described examples, various kinds of information may be considered to determine (or select) the electronic device to provide the cross-connection function.

In the case of determining (or selecting) the electronic device 100 as the electronic device to provide the cross-connection function, the electronic device 100 may control the communication circuitry 610 to transmit the service discovery frame including information indicating the electronic device (e.g., the electronic device 100) to provide the cross-connection function to the external electronic device 503. Upon receiving the service discovery frame including information indicating the electronic device (e.g., the electronic device 100) to provide the cross-connection function, the external electronic device 503 may release the connection via short-range wireless communication between the external electronic device 503 and the second AP 502.

In operation 1130, the electronic device 100 may transmit schedule information related to performing NAN communication and performing communication using the cross-connection to the external electronic device 503.

In the process of configuring NAN communication between the electronic device 100 and the external electronic device 503, the electronic device 100 may conFIGURE(or generate) schedule information related to performing NAN communication and performing communication using the cross-connection function.

The electronic device 100 may conFIGURE(or generate) schedule information to perform communication using the cross-connection function during at least a portion of the period between the discovery windows 450. The electronic device 100 may conFIGURE(or generate) schedule information to perform NAN communication during another portion of the period between the discovery windows 450.

According to an example, in a section, configured to perform communication using the cross-connection function, of the period between the discovery windows 450, a channel of an NDP established between the electronic device 100 and the external electronic device 503 may be the same as a channel established between the electronic device 100 and the first AP 501. The electronic device 100 may configure schedule information to perform NAN communication using the same channel as the channel established between the electronic device 100 and the first AP 501, and the electronic device 100 may simultaneously perform short-range wireless communication between the first AP 501 and the electronic device 100 and NAN communication between the electronic device 100 and the external electronic device 503 in the section, configured to perform communication using the cross-connection function, of the period between the discovery windows 450.

According to an example, in a section, configured to perform NAN communication, of the period between the discovery windows 450, a channel of an NDP established between the electronic device 100 and the external electronic device 503 may be the same as a channel configured in an NAN cluster (e.g., the NAN cluster 200 in FIG. 2) including the electronic device 100 and the external electronic device 503. Alternatively, in a section, configured to perform NAN communication, of the period between the discovery windows 450, a channel of an NDP established between the electronic device 100 and the external electronic device 503 may be different from a channel established between the electronic device 100 and the first AP 501. The electronic device 100 may perform NAN communication with the external electronic device 503 in the section, configured to perform NAN communication, of the period between the discovery windows 450. The electronic device 100 may not perform short-range wireless communication between the first AP 501 and the electronic device 100 in the section, configured to perform NAN communication, of the period between the discovery windows 450.

Based on the above-described scheme, through the cross-connection function, the electronic device 100 and the external electronic device 503 may perform NAN communication during the period between the discovery windows 450 and also perform both NAN communication and communication using the cross-connection function during at least a portion of the period between the discovery windows 450.

According to an example, in the section, configured to perform NAN communication, of the period between the discovery windows 450, the channel of the NDP established between the electronic device 100 and the external electronic device 503 may be configured to be identical to the channel established between the electronic device 100 and the first AP 501. That is, in the section between the discovery windows 450, the channel established between the electronic device 100 and the external electronic device 503 may be configured to be identical to the channel established between the electronic device 100 and the first AP 501. Therefore, the electronic device 100 may simultaneously perform short-range wireless communication between the first AP 501 and the electronic device 100 and NAN communication between the electronic device 100 and the external electronic device 503 during, of the period between the discovery windows 450, both the section configured to perform communication using the cross-connection function and the section configured to perform NAN communication.

An electronic device according to an example may include communication circuitry 610 supporting short-range wireless communication and neighbor awareness network (NAN) communication. The electronic device may include a memory 630 storing at least one computer program. The electronic device may include at least one processor 620. The at least one computer program may include instructions that, when executed by the at least one processor 620 individually or collectively, cause the electronic device to be connected to a first AP 501 via the short-range wireless communication. The instructions may cause, when executed by the at least one processor 620 individually or collectively, the electronic device to receive, from an external electronic device 503, a service discovery frame in a process of discovering the external electronic device 503 to be connected through a first NDP. The service discovery frame may include information related to a second AP 502 connected to the external electronic device 503 and/or information indicating whether a cross-connection which is a function enabling the electronic device to be connected to the second AP 502 via the external electronic device 503 is supported. The instructions may cause, when executed by the at least one processor 620 individually or collectively, the electronic device to activate, based on the service discovery frame, the cross-connection enabling the external electronic device 503 to be connected to the first AP 501 via the electronic device. The instructions may cause, when executed by the at least one processor 620 individually or collectively, the electronic device to transmit, to the external electronic device 503, schedule information related to performing the NAN communication via the first NDP and performing the short-range wireless communication using the cross-connection. The schedule information may enable the electronic device and the external electronic device 503 to perform the NAN communication and the short-range wireless communication using the cross-connection during a first period 721 between discovery windows 511, 512, 513 and perform the NAN communication during a second period 722 between the discovery windows.

In the electronic device according to an example, the schedule information may enable the electronic device and the external electronic device 503 to perform the NAN communication and the short-range wireless communication using the cross-connection via a first channel during the first period 721 and perform the NAN communication via a second channel during the second period 722.

In the electronic device according to an example, the second channel may be configured to be same as a channel between the electronic device and the first AP 501.

In the electronic device according to an example, the schedule information may enable the electronic device and the external electronic device 503 to perform the NAN communication and the short-range wireless communication using the cross-connection during a period between the discovery windows 511, 512, 513 in case where the schedule information is configured such that the first channel and the second channel are same.

In the electronic device according to an example, the schedule information may enable the electronic device and the external electronic device 503 to perform the NAN communication during a period between the discovery windows 511, 512, 513.

In the electronic device according to an example, the instructions may cause, when executed by the at least one processor, the electronic device to activate, based on the service discovery frame, the cross-connection enabling the electronic device to be connected to the second AP 502 via the external electronic device 503. The instructions may cause, when executed by the at least one processor, the electronic device to receive, from the external electronic device 503, schedule information related to the electronic device and the external electronic device 503 performing the NAN communication via the first NDP and performing the short-range wireless communication using the cross-connection. The schedule information may enable the electronic device and the external electronic device 503 to perform the NAN communication and the short-range wireless communication using the cross-connection during the first period 721 and perform the NAN communication during the second period 722.

In the electronic device according to an example, the instructions may cause the external electronic device 503 to establish a second NDP for performing the short-range wireless communication using the cross-connection. The schedule information may enable the electronic device and the external electronic device 503 to perform the NAN communication and the short-range wireless communication using the cross-connection via the second NDP during the first period 721 and perform the NAN communication via the first NDP during the second period 722.

In a recording medium storing at least one program including instructions that, when executed by at least one processor 620 of an electronic device individually or collectively, cause the electronic device to perform operations, the instructions may cause, when executed by the at least one processor 620 individually or collectively, the electronic device to receive, from an external electronic device 503, a service discovery frame in a process of discovering the external electronic device 503 to be connected through a first NDP of NAN communication. The service discovery frame may include information related to a second AP 502 connected to the external electronic device 503 and/or information indicating whether a cross-connection which is a function enabling the electronic device to be connected to the second AP 502 via the external electronic device 503 is supported. The instructions may cause, when executed by the at least one processor 620 individually or collectively, the electronic device to activate, based on the service discovery frame, the cross-connection enabling the external electronic device 503 to be connected to a first AP 501 via the electronic device. The instructions may cause, when executed by the at least one processor 620 individually or collectively, the electronic device to transmit, to the external electronic device 503, schedule information related to performing the NAN communication via the first NDP and performing the short-range wireless communication using the cross-connection. The schedule information may enables the electronic device and the external electronic device 503 to perform the NAN communication and the short-range wireless communication using the cross-connection during a first period 721 between discovery windows 511, 512, 513 and perform the NAN communication during a second period 722 between the discovery windows.

In the recording medium according to an example, the schedule information may enable the electronic device and the external electronic device 503 to perform the NAN communication and the short-range wireless communication using the cross-connection via a first channel during the first period 721 and perform the NAN communication via a second channel during the second period 722.

In the recording medium according to an example, the second channel may be configured to be same as a channel between the electronic device and the first AP 501.

In the recording medium according to an example, the schedule information may enable the electronic device and the external electronic device 503 to perform the NAN communication and the short-range wireless communication using the cross-connection during a period between the discovery windows 511, 512, 513 in case where the schedule information is configured such that the first channel and the second channel are same.

In the recording medium according to an example, the schedule information may enable the electronic device and the external electronic device 503 to perform the NAN communication during a period between the discovery windows 511, 512, 513.

In the recording medium according to an example, the instructions may cause, when executed by the at least one processor individually or collectively, the electronic device to activate, based on the service discovery frame, the cross-connection enabling the electronic device to be connected to the second AP 502 via the external electronic device 503. The instructions may cause, when executed by the at least one processor individually or collectively, the electronic device to receive, from the external electronic device 503, schedule information related to the electronic device and the external electronic device 503 performing the NAN communication via the first NDP and performing the short-range wireless communication using the cross-connection. The schedule information may enable the electronic device and the external electronic device 503 to perform the NAN communication and the short-range wireless communication using the cross-connection during the first period 721 and perform the NAN communication during the second period 722.

An electronic device according to an example may include a communication circuitry 610 supporting short-range wireless communication and neighbor awareness network (NAN) communication. The electronic device may include a memory 630 storing at least one computer program. The electronic device may include at least one processor 620. The at least one computer program may include instructions that, when executed by the at least one processor 620 individually or collectively, cause the electronic device to be connected to a first AP 501 via the short-range wireless communication. The instructions may cause, when executed by the at least one processor 620 individually or collectively, the electronic device to receive, from an external electronic device 503, a service discovery frame in a process of discovering the external electronic device 503 to be connected through a first NDP of the NAN communication. The service discovery frame may include information related to a second AP 502 connected to the external electronic device 503 and/or information indicating whether a cross-connection which is a function enabling the electronic device to be connected to the second AP 502 via the external electronic device 503 is supported. The instructions may cause, when executed by the at least one processor 620 individually or collectively, the electronic device to activate, based on the service discovery frame, the cross-connection enabling the electronic device to be connected to the second AP 502 via the external electronic device 503. The instructions may cause, when executed by the at least one processor 620 individually or collectively, the electronic device to transmit, to the external electronic device 503, schedule information related to the electronic device and the external electronic device 503 performing communication via the first NDP and performing the short-range wireless communication using the cross-connection. The schedule information may enable the electronic device and the external electronic device 503 to perform the NAN communication and the short-range wireless communication using the cross-connection during a first period 721 between discovery windows 511, 512, 513 and perform the NAN communication during a second period 722 between the discovery windows.

An operating method of an electronic device according to an example may include an operation of receiving, from an external electronic device 503, a service discovery frame in a process of discovering the external electronic device 503 to be connected through a first NDP of NAN communication, wherein the service discovery frame includes information related to a second AP 502 connected to the external electronic device 503 and/or information indicating whether a cross-connection which is a function enabling the electronic device to be connected to the second AP 502 via the external electronic device 503 is supported. The operating method of the electronic device may include an operation of activating, based on the service discovery frame, the cross-connection enabling the external electronic device 503 to be connected to a first AP 501 via the electronic device. The operating method of the electronic device may include an operation of transmitting, to the external electronic device 503, schedule information related to the electronic device and the external electronic device 503 performing the NAN communication via the first NDP and performing the short-range wireless communication using the cross-connection. The schedule information may enable the electronic device and the external electronic device 503 to perform the NAN communication and the short-range wireless communication using the cross-connection during a first period 721 between discovery windows 511, 512, 513 and perform the NAN communication during a second period 722 between the discovery windows.

In the operating method of the electronic device according to an example, the schedule information may enable the electronic device and the external electronic device 503 to perform the NAN communication and the short-range wireless communication using the cross-connection via a first channel during the first period 721 and perform the NAN communication via a second channel during the second period 722.

In the operating method of the electronic device according to an example, the second channel may be configured to be same as a channel between the electronic device and the first AP 501.

In the operating method of the electronic device according to an example, the schedule information may enable the electronic device and the external electronic device 503 to perform the NAN communication and the short-range wireless communication using the cross-connection during a period between the discovery windows 511, 512, 513 in case where the schedule information is configured such that the first channel and the second channel are same.

In the operating method of the electronic device according to an example, the schedule information may enable the electronic device and the external electronic device 503 to perform the NAN communication during a period between the discovery windows 511, 512, 513.

The operating method of the electronic device according to an example may further include an operation of activating, based on the service discovery frame, the cross-connection enabling the electronic device to be connected to the second AP 502 via the external electronic device 503. The operating method of the electronic device may further include an operation of receiving, from the external electronic device 503, schedule information related to the electronic device and the external electronic device 503 performing the NAN communication via the first NDP and performing the short-range wireless communication using the cross-connection. The schedule information may enable the electronic device and the external electronic device 503 to perform the NAN communication and the short-range wireless communication using the cross-connection during the first period 721 and perform the NAN communication during the second period 722.

What is claimed is:

1. An electronic device comprising:
communication circuitry configured to support short-range wireless communication and neighbor awareness network (NAN) communication;
a memory storing at least one computer program; and
at least one processor operatively connected with the communication circuitry and the memory,
wherein the at least one computer program includes instructions that, when executed by the at least one processor individually or collectively, cause the electronic device to:
connect to a first access point (AP) via the short-range wireless communication,
receive, from an external electronic device, a service discovery frame during discovering the external electronic device to be connected through a first NAN data path (NDP), wherein the service discovery frame includes: first information related to a second AP connected to the external electronic device, and/or second information indicating whether a cross-connection is supported, wherein the cross-connection is a function enabling the electronic device to be connected to the second AP via the external electronic device,
activate, based on the service discovery frame, the cross-connection enabling the external electronic device to be connected to the first AP via the electronic device, and
transmit, to the external electronic device, schedule information related to the NAN communication via the first NDP and the short-range wireless communication using the cross-connection, and
wherein the schedule information causes the electronic device and the external electronic device to perform the NAN communication and the short-range wireless communication using the cross-connection during a first period between discovery windows and perform the NAN communication during a second period between the discovery windows.

2. The electronic device of claim 1, wherein the schedule information causes the electronic device and the external electronic device to perform the NAN communication and the short-range wireless communication using the cross-connection via a first channel during the first period and perform the NAN communication via a second channel during the second period.

3. The electronic device of claim 2, wherein the second channel is configured to be the same as a channel between the electronic device and the first AP.

4. The electronic device of claim 2, wherein the schedule information causes the electronic device and the external electronic device to perform the NAN communication and the short-range wireless communication using the cross-connection during a period between the discovery windows in case where the schedule information is configured such that the first channel and the second channel are same.

5. The electronic device of claim 1, wherein the schedule information causes the electronic device and the external electronic device to perform the NAN communication during a period between the discovery windows.

6. The electronic device of claim 1, wherein the instructions, when executed by the at least one processor, cause the electronic device to:
activate, based on the service discovery frame, the cross-connection enabling the electronic device to be connected to the second AP via the external electronic device, and
receive, from the external electronic device, the schedule information related to the electronic device and the external electronic device configured to perform the NAN communication via the first NDP and to perform the short-range wireless communication using the cross-connection, and
wherein the schedule information causes the electronic device and the external electronic device to perform the NAN communication and the short-range wireless communication using the cross-connection during the first period and perform the NAN communication during the second period.

7. The electronic device of claim 1, wherein the instructions cause the external electronic device to establish a second NDP for performing the short-range wireless communication using the cross-connection, and
the schedule information causes the electronic device and the external electronic device to perform the NAN communication and the short-range wireless communication using the cross-connection via the second NDP during the first period and perform the NAN communication via the first NDP during the second period.

8. A non-transitory recording medium storing at least one program including instructions that, when executed by at least one processor of an electronic device individually or collectively, cause the electronic device to:
receive, from an external electronic device, a service discovery frame during discovering the external electronic device to be connected through a first neighbor awareness network (NAN) data path (NDP) of NAN communication, wherein the service discovery frame includes: first information related to a second access point (AP) connected to the external electronic device and/or second information indicating whether a cross-connection is supported, wherein the cross-connection is a function enabling the electronic device to be connected to the second AP via the external electronic device,
activate, based on the service discovery frame, the cross-connection enabling the external electronic device to be connected to a first AP via the electronic device, and
transmit, to the external electronic device, schedule information related to the NAN communication via the first NDP and short-range wireless communication using the cross-connection,
wherein the schedule information causes the electronic device and the external electronic device to perform the NAN communication and the short-range wireless communication using the cross-connection during a first period between discovery windows and perform the NAN communication during a second between the discovery windows.

9. The non-transitory recording medium of claim 8, wherein the schedule information causes the electronic device and the external electronic device to perform the NAN communication and the short-range wireless communication using the cross-connection via a first channel during the first period and to perform the NAN communication via a second channel during the second period.

10. The non-transitory recording medium of claim 9, wherein the second channel is configured to be the same as a channel between the electronic device and the first AP.

11. The non-transitory recording medium of claim 9, wherein, based on the schedule information that is configured such that the first channel and the second channel are the same, the electronic device and the external electronic device are further configured to perform the NAN communication and the short-range wireless communication using the cross-connection during a period between the discovery windows.

12. The non-transitory recording medium of claim 8, wherein the schedule information causes the electronic device and the external electronic device to perform the NAN communication during a period between the discovery windows.

13. The non-transitory recording medium of claim 8, wherein the instructions, when executed by the at least one processor individually or collectively, cause the electronic device to:
activate, based on the service discovery frame, the cross-connection enabling the electronic device to be connected to the second AP via the external electronic device, and
receive, from the external electronic device, the schedule information related to the electronic device and the external electronic device configured to perform the NAN communication via the first NDP and to perform the short-range wireless communication using the cross-connection, and
wherein the schedule information causes the electronic device and the external electronic device to perform the NAN communication and the short-range wireless communication using the cross-connection during the first period and to perform the NAN communication during the second period.

14. An operating method of an electronic device, the method comprising:
receiving, from an external electronic device, a service discovery frame, during discovering the external electronic device to be connected through a first neighbor awareness network (NAN) data path (NDP) of NAN communication, wherein the service discovery frame includes: first information related to a second access point (AP) connected to the external electronic device, and/or second information indicating whether a cross-connection is supported, wherein the cross-connection is a function enabling the electronic device to be connected to the second AP via the external electronic device,
activating, based on the service discovery frame, the cross-connection enabling the external electronic device to be connected to a first AP via the electronic device, and
transmitting, to the external electronic device, schedule information related to the electronic device and the external electronic device configured to perform the NAN communication via the first NDP and to perform short-range wireless communication using the cross-connection,
wherein the schedule information causes the electronic device and the external electronic device to perform the NAN communication and the short-range wireless communication using the cross-connection during a first period between discovery windows and to perform the NAN communication during a second period between the discovery windows.

15. The method of claim 14, wherein the schedule information causes the electronic device and the external electronic device to perform the NAN communication and the short-range wireless communication using the cross-connection via a first channel during the first period and to perform the NAN communication via a second channel during the second period.

16. The method of claim 15, wherein the second channel is the same as a channel between the electronic device and the first AP.

17. The method of claim 16, wherein, based on the schedule information configured such that the first channel and the second channel are the same, the electronic device and the external electronic device are further configured to perform the NAN communication and the short-range wireless communication using the cross-connection during a period between the discovery windows.

18. The method of claim 14, wherein, based on the schedule information, the electronic device and the external electronic device are further configured to perform the NAN communication during a period between the discovery windows.

19. The method of claim 14, further comprising:
activating, based on the service discovery frame, the cross-connection enabling the electronic device to be connected to the second AP via the external electronic device; and
receiving, from the external electronic device, schedule information related to the electronic device and the external electronic device configured to perform the NAN communication via the first NDP and to perform the short-range wireless communication using the cross-connection, and
wherein, based on the schedule information, the electronic device and the external electronic device are further configured to perform the NAN communication and the short-range wireless communication using the cross-connection during the first period and to perform the NAN communication during the second period.
